(19) United States
(12) Patent Application Publication
(10) Pub. No.: US 2011/0242460 A1
(43) Pub. Date: Oct. 6, 2011

(54) CELLULOSE ACYLATE FILM AND METHOD FOR MANUFACTURING THE SAME, RETARDATION FILM, POLARIZING PLATE, AND LIQUID CRYSTAL DISPLAY DEVICE

(75) Inventors: Takayasu YASUDA, Ashigarakami-gun (JP); Toshihiro KAMADA, Ashigarakami-gun (JP); Masato NAGURA, Ashigarakami-gun (JP)

(73) Assignee: FUJIFILM CORPORATION, Tokyo (JP)

(21) Appl. No.: 13/075,788

(22) Filed: Mar. 30, 2011

(30) Foreign Application Priority Data
Mar. 31, 2010 (JP) 2010-083039

(51) Int. Cl. G02F 1/1335; C08L 1/08; G02B 5/30

(52) U.S. Cl. 349/96; 524/35; 359/489.07

(57) ABSTRACT

A cellulose acylate film containing a polymer having a repeating unit represented by the following formula (1) and a cellulose acylate.

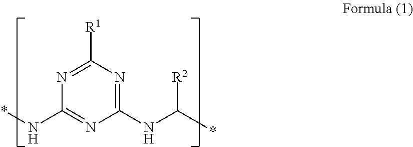

wherein R¹ represents an alkyl group having 2 or more carbon atoms, an alkenyl group, an alkynyl group, an aryl group or a heterocyclic group; and R² represents an alkyl group, an alkenyl group, an alkynyl group, an aryl group or a heterocyclic group.

### CROSS-REFERENCE TO RELATED APPLICATIONS

The present application claims the benefit of priority from Japanese Patent Application No. 2010-083039, filed on Mar. 31, 2010, the contents of which are herein incorporated by reference in their entirety.

### BACKGROUND OF THE INVENTION

1. Field of the Invention

The present invention relates to a cellulose acylate film and a method for producing the same, a retardation film and a polarizing plate and a liquid crystal display device each including the same, especially a liquid crystal display device of a VA (vertical aligned) mode.

2. Background Art

In recent years, display characteristics of liquid crystal display devices are increasing more and more. In particular, in liquid crystal display devices of a VA mode which are promising as liquid crystal display devices for large-sized television set, it is known that by disposing two sheets of polarizing plates on each of the display surface side and the backlight side of a liquid crystal cell in such a manner that their absorption axes are orthogonal to each other and further disposing an optically biaxial retardation film between each of the polarizing plates and the liquid crystal cell, a wider viewing angle can be realized, namely the display characteristics can be enhanced.

In recent years, as such a retardation film, a cellulose acylate film having an excellent optical performance, specifically one capable of developing in-plane retardation Re (nm) and retardation Rth (nm) in a thickness direction of the retardation film, is being watched, and such a cellulose acylate film is used as a retardation film for liquid crystal display devices. Also, in recent years, a use environment of the liquid crystal display device has diversified, and it is demanded to exhibit stable display characteristics under an environment where a change in humidity including the outdoors is large.

It is known that such a cellulose acylate is able to improve film characteristics by the addition of various additives. An amino resin such as a benzoguanamine resin or an amino resin precursor can also be added to the cellulose acylate film, and examples regarding the actual use thereof are investigated in Patent Documents 1 (JP-A-2007-23157) and 2 (JP-T-2008-546011). Patent Document 1 describes working examples in which a benzoguanamine resin precursor that is an amino resin precursor and a crosslinking agent are added to a cellulose acylate dope, and the mixture is then subjected to polycondensation and crosslinking bonding, followed by film formation. According to Patent Document 1, it is described that by allowing the benzoguanamine resin precursor to crosslinking with an OH group of the cellulose acylate, the durability against changes in temperature and relative humidity can be improved. However, Patent Document 1 describes only an example in which the benzoguanamine resin precursor obtained by methylolating benzoguanamine with formaldehyde is used, but it does not describe the preparation of a benzoguanamine precursor using other aldehyde. Also, Patent Document 1 does not describe any example in which the benzoguanamine resin in a polycondensed state is added to the cellulose acylate dope.

Patent Document 2 describes that a crosslinking agent that is an amino resin precursor is used as an additive of a cellulose ester. In the working examples of Patent Document 2, though only an example in which hexamethoxymethyl melamine (CYMEL (registered trademark) 303) prepared by treating melamine with formaldehyde is used as the crosslinking agent (amino resin precursor) is described, any example in which a benzoguanamine resin or its precursor is used is not described. Also, though Patent Document 2 describes that it is preferable to undergo a crosslinking reaction of all of hydroxyl groups of the cellulose acylate with the crosslinking agent, Patent Document 2 does not describe any example in which the amino resin in a polycondensed state is added to the cellulose acylate dope.

### SUMMARY OF THE INVENTION

Under such circumstances, for the purpose of suppressing fluctuations in Re and Rth against changes in humidity of the use environment (hereinafter also referred to as humidity dependency of Re and Rth), the present inventors made investigation regarding the foregoing characteristics of the cellulose acylate film when various additives are used.

Then, the present inventors formed films by adding an amino resin precursor obtained by methylolation using formaldehyde as described in Patent Documents 1 and 2 to a cellulose acylate dope according to the method described in each of the foregoing patent documents and made investigations regarding the humidity dependency of optical characteristics and the like. However, in the case of using the amino resin precursor described in each of these patent documents, it was noted that the resulting cellulose acylate films are low in redissolution properties in general organic solvents such as methylene chloride so that they are not preferable from the standpoint of manufacturing adaptability. Also, it was noted that such cellulose acylate films are dissatisfied with the humidity dependency of Re and Rth.

That is, a problem to be solved by the invention is to provide a cellulose acylate film capable of suppressing fluctuations in Re and Rth against changes in humidity of the use environment and having favorable redissolution properties and a method for manufacturing the same.

On the basis of such knowledge, the present inventors made extensive and intensive investigations regarding an additive capable of improving the humidity dependency of Re and Rth and having favorable redissolution properties. As a result, it has been found that when a polymer obtained by polycondensing an amino resin having a 1,3,5-triazine ring having a certain specified substituent using a specified aldehyde other than formaldehyde is added as an additive to a cellulose acylate dope, not only the humidity dependency of Re and Rth are conspicuously improved, but the redissolution properties become favorable.

Specifically, means for solving the foregoing problem are as follows.
[1] A cellulose acylate film comprising a polymer having a repeating unit represented by the following formula (1) and a cellulose acylate.

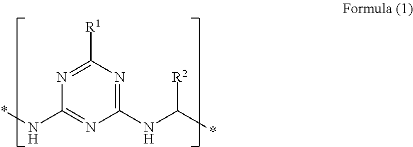

wherein R¹ represents an alkyl group having 2 or more carbon atoms, an alkenyl group, an alkynyl group, an aryl group or a heterocyclic group; and R² represents an alkyl group, an alkenyl group, an alkynyl group, an aryl group or a heterocyclic group.
[2] The cellulose acylate film according to [1], wherein in the formula (1), R¹ is an alkyl group having 2 or more carbon atoms or an aryl group.
[3] The cellulose acylate film according to [1], wherein in the formula (1), R¹ is a phenyl group.
[4] The cellulose acylate film according to any one of [1] to [3], wherein in the formula (1), R² is an alkyl group or an aryl group.
[5] The cellulose acylate film according to any one of [1] to [4], wherein the polymer having a repeating unit represented by the formula (1) has a weight average molecular weight of from 500 to 10,000.
[6] The cellulose acylate film according to any one of [1] to [5], wherein the cellulose acylate does not form a crosslinking structure with the polymer having a repeating unit represented by the formula (1).
[7] The cellulose acylate film according to any one of [1] to [6], wherein hydroxyl groups of the cellulose constituting the cellulose acylate are substituted with only an acyl group.
[8] The cellulose acylate film according to any one of [1] to [7], wherein the cellulose acylate has a total degree of acyl substitution of from 1.5 to 3.
[9] A method for manufacturing a cellulose acylate film comprising:

polycondensing a compound represented by the following formula (2) and a compound represented by the following formula (3) (provided that other compound may be used as a copolymerization component) to obtain a polymer,

mixing the polymer with a cellulose acylate to prepare a dope, and

subjecting the dope to solution casting film formation to obtain a cellulose acylate film.

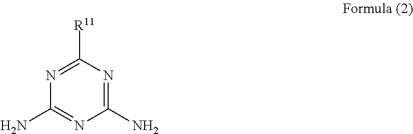

wherein R¹¹ represents an alkyl group having 2 or more carbon atoms, an alkenyl group, an alkynyl group, an aryl group or a heterocyclic group.

R¹²—CHO Formula (3)

wherein R¹² represents an alkyl group, an alkenyl group, an alkynyl group, an aryl group or a heterocyclic group.
[10] The method for manufacturing a cellulose acylate film according to [9], wherein the polycondensation is carried out in the presence of an acid substance.
[11] The method for manufacturing a cellulose acylate film according to [9] or [10], wherein the polycondensation is carried out in the absence of a solvent.
[12] The method for manufacturing a cellulose acylate film according to any one of [9] to [11], wherein the polymer is synthesized while controlling such that the polymer after completion of the polycondensation does not contain a functional group capable of undergoing a crosslinking reaction with hydroxyl groups of the cellulose acylate.
[13] The method for manufacturing a cellulose acylate film according to any one of [9] to [12], which further comprises:

preparing the cellulose acylate by acylating hydroxyl groups of the cellulose with an acylating agent, thereby obtaining the cellulose acylate film under a condition under which the hydroxyl groups of the cellulose do not react with other material than the acylating agent.
[14] A cellulose acylate film manufactured by the method for manufacturing a cellulose acylate film of any one of [9] to [13].
[15] A retardation film comprising the cellulose acylate film of any one of [1] to [8] and [14].
[16] A polarizing plate comprising a polarizer and the retardation film of [15].
[17] A liquid crystal display device comprising the polarizing plate of [16].

The cellulose acylate film of the invention is able to suppress fluctuations in Re and Rth against changes in humidity of the use environment and has favorable redissolution properties, and therefore, it can be suitably used for a retardation film in a liquid crystal display device and a polarizing plate, in particular, it can be suitably used for a liquid crystal display device of the invention.

### BRIEF DESCRIPTION OF THE DRAWING

FIG. 1 is a schematic view showing a configuration of an example of a liquid crystal display device of the invention. In the drawing, 1 is upper substrate of liquid crystal cell, 3 is lower substrate of liquid crystal cell, 5 is liquid crystal layer (liquid crystal molecule), 8a and 8b are protective film of polarizing plate, 9a and 9b are absorption axis of protective film of polarizing plate, 10a and 10b are retardation film (the cellulose acylate film of the invention), 11a and 11b are absorption axis of retardation film (the cellulose acylate film of the invention), P1 and P2 are polarizing plate, and LC is liquid crystal cell.

### BEST MODE FOR CARRYING OUT THE INVENTION

The invention is hereunder described in detail. The following description regarding constitutional elements may be made on the basis of representative embodiments of the invention, but it should not be construed that the invention is limited to these embodiments. In this specification, a numerical range expressed by the terms “a number to another number” means a range falling between the former number indicating a lower limit value of the range and the latter number indicating an upper limit value thereof.

Also, in this specification, it should be construed that numerical values, numerical value ranges and qualitative expressions (for example, “same” or “equal” expressions) show numerical values, numerical value ranges and properties including generally tolerable errors with respect to the liquid crystal display devices and members used therein.

### [Cellulose Acylate Film]

The cellulose acylate film of the invention (hereinafter also referred to as “film of the invention”) contains a polymer having a repeating unit represented by the following formula (1) and a cellulose acylate.

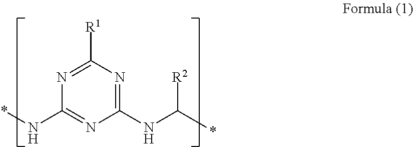

In the formula (1), R¹ represents an alkyl group having 2 or more carbon atoms, an alkenyl group, an alkynyl group, an aryl group or a heterocyclic group; and R² represents an alkyl group, an alkenyl group, an alkynyl group, an aryl group or a heterocyclic group.

By taking such a constitution, the film of the invention is able to suppress fluctuations in Re and Rth against changes in humidity of the use environment and has favorable redissolution properties.

Irrespective of any theories, it may be supposed that the humidity dependency of Re and Rth of the cellulose acylate film is generated by a change in birefringence of the cellulose acylate to be caused due to the fact that a water molecule coordinates to a carbonyl group existent on the acyl substituent of the cellulose acylate. Similarly, irrespective of any theories, since the polymer having a repeating unit represented by the formula (1), which is used in the invention, has a hydrogen-bondable group at an appropriate position, it effectively interacts on the carbonyl groups or hydroxyl groups of the cellulose acylate, thereby enabling an approach of the water molecule to the cellulose acylate in a high-humidity state to be inhibited. That is, the invention pays attention to a structure of a compound having a 1,3,5-triazine ring, in particular, disposition of a substituent at an appropriate position.

Preferred embodiments of the film of the invention are hereunder described.

<Polymer having a Repeating Unit Represented by the Formula (1)>

First of all, the polymer having a repeating unit represented by the formula (1) is described. In this connection, in this specification, hydrocarbon groups such as an alkyl group may be linear or branched so far as the gist of the invention is not deviated.

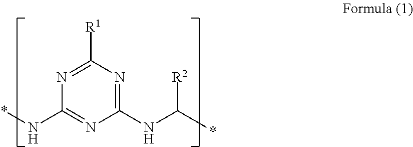

(Structure of the Polymer having a Repeating Unit Represented by the Formula (1))

R¹ represents an alkyl group having 2 or more carbon atoms, an alkenyl group, an alkynyl group, an aryl group or a heterocyclic group. R¹ is preferably an alkyl group having 2 or more carbon atoms or an aryl group, and more preferably a phenyl group from the viewpoint of improving the humidity dependency.

When R¹ is an alkyl group, the alkyl group is preferably one having from 2 to 20 carbon atoms, more preferably one having from 2 to 12 carbon atoms, and especially preferably one having from 2 to 8 carbon atoms.

When R¹ is an alkenyl group, the alkenyl group is preferably one having from 2 to 20 carbon atoms, more preferably one having from 3 to 15 carbon atoms, and especially preferably one having from 6 to 12 carbon atoms.

When R¹ is an alkynyl group, the alkynyl group is preferably one having from 2 to 20 carbon atoms, more preferably one having from 3 to 15 carbon atoms, and especially preferably one having from 6 to 12 carbon atoms.

When R¹ is an aryl group, the aryl group is preferably one having from 6 to 24 carbon atoms, more preferably one having from 6 to 18 carbon atoms, and especially preferably one having 6 carbon atoms from the viewpoint of improving the humidity dependency.

When R¹ is a heterocyclic group, the heterocyclic group is preferably one having from 4 to 23 carbon atoms, more preferably one having from 4 to 17 carbon atoms, and especially preferably one having 5 carbon atoms from the viewpoint of improving the humidity dependency.

Though R¹ may further have a substituent or may not have a substituent, that R¹ does not further have a substituent is preferable from the viewpoint of improving the humidity dependency.

Examples of the substituent which R¹ may have include the following substituents T. Examples of the substituents T include an alkyl group (preferably one having from 1 to 20 carbon atoms, more preferably one having from 1 to 12 carbon atoms, and especially preferably one having from 1 to 8 carbon atoms; for example, a methyl group, an ethyl group, an isopropyl group, a tert-butyl group, an n-octyl group, an n-decyl group, an n-hexadecyl group, a cyclopropyl group, a cyclopentyl group, a cyclohexyl group, etc.), an alkenyl group (preferably one having from 2 to 20 carbon atoms, more preferably one having from 2 to 12 carbon atoms, and especially preferably one having from 2 to 8 carbon atoms; for example, a vinyl group, an allyl group, a 2-butenyl group, a 3-pentenyl group, etc.), an alkynyl group (preferably one having from 2 to 20 carbon atoms, more preferably one having from 2 to 12 carbon atoms, and especially preferably one having from 2 to 8 carbon atoms; for example, a propargyl group, a 3-pentynyl group, etc.), an aryl group (preferably one having from 6 to 30 carbon atoms, more preferably one having from 6 to 20 carbon atoms, and especially preferably one having from 6 to 12 carbon atoms; for example, a phenyl group, a biphenyl group, a naphthyl group, etc.), an amino group (preferably one having from 0 to 20 carbon atoms, more preferably one having from 0 to 10 carbon atoms, and especially preferably one having from 0 to 6 carbon atoms; for example, an amino group, a methylamino group, a dimethylamino group, a diethylamino group, a dibenzylamino group, etc.), an alkoxy group (preferably one having from 1 to 20 carbon atoms, more preferably one having from 1 to 12 carbon atoms, and especially preferably one having from 1 to 8 carbon atoms; for example, a methoxy group, an ethoxy group, a butoxy group, etc.), an aryloxy group (preferably one having from 6 to 20 carbon atoms, more preferably one having from 6 to 16 carbon atoms, and especially preferably one having from 6 to 12 carbon atoms; for example, a phenyloxy group, a 2-naphthyloxy group, etc.), an acyl group (preferably one having from 1 to 20 carbon atoms, more preferably one having from 1 to 16 carbon atoms, and especially preferably one having from 1 to 12 carbon atoms; for example, an acetyl group, a benzoyl group, a formyl group, a pivaloyl group, etc.), an alkoxycarbonyl group (preferably one having from 2 to 20 carbon atoms, more preferably one having from 2 to 16 carbon atoms, and especially preferably one having from 2 to 12 carbon atoms; for example, a methoxycarbonyl group, an ethoxycarbonyl group, etc.), an aryloxycarbonyl group (preferably one having from 7 to 20 carbon atoms, more preferably one having from 7 to 16 carbon atoms, and especially preferably one having from 7 to 10 carbon atoms; for example, a phenyloxycarbonyl group, etc.), an acyloxy group (preferably one having from 2 to 20 carbon atoms, more preferably one having from 2 to 16 carbon atoms, and especially preferably one having from 2 to 10 carbon atoms; for example, an acetoxy group, a benzoyloxy group, etc.), an acylamino group (preferably one having from 2 to 20 carbon atoms, more preferably one having from 2 to 16 carbon atoms, and especially preferably one having from 2 to 10 carbon atoms; for example, an acetylamino group, a benzoylamino group, etc.), an alkoxycarbonylamino group (preferably one having from 2 to 20 carbon atoms, more preferably one having from 2 to 16 carbon atoms, and especially preferably one having from 2 to 12 carbon atoms; for example, a methoxycarbonylamino group, etc.), an aryloxycarbonylamino group (preferably one having from 7 to 20 carbon atoms, more preferably one having from 7 to 16 carbon atoms, and especially preferably one having from 7 to 12 carbon atoms; for example, a phenyloxycarbonylamino group, etc.), a sulfonylamino group (preferably one having from 1 to 20 carbon atoms, more preferably one having from 1 to 16 carbon atoms, and especially preferably one having from 1 to 12 carbon atoms; for example, a methanesulfonylamino group, a benzenesulfonylamino group, etc.), a sulfamoyl group (preferably one having from 0 to 20 carbon atoms, more preferably one having from 0 to 16 carbon atoms, and especially preferably one having from 0 to 12 carbon atoms; for example, a sulfamoyl group, a methylsulfamoyl group, a dimethylsulfamoyl group, a phenylsulfamoyl group, etc.), a carbamoyl group (preferably one having from 1 to 20 carbon atoms, more preferably one having from 1 to 16 carbon atoms, and especially preferably one having from 1 to 12 carbon atoms; for example, a carbamoyl group, a methylcarbamoyl group, a diethylcarbamoyl group, a phenylcarbamoyl group, etc.), an alkylthio group (preferably one having from 1 to 20 carbon atoms, more preferably one having from 1 to 16 carbon atoms, and especially preferably one having from 1 to 12 carbon atoms; for example, a methylthio group, an ethylthio group, etc.), an arylthio group (preferably one having from 6 to 20 carbon atoms, more preferably one having from 6 to 16 carbon atoms, and especially preferably one having from 6 to 12 carbon atoms; for example, a phenylthio group, etc.), a sulfonyl group (preferably one having from 1 to 20 carbon atoms, more preferably one having from 1 to 16 carbon atoms, and especially preferably one having from 1 to 12 carbon atoms; for example, a mesyl group, a tosyl group, etc.), a sulfinyl group (preferably one having from 1 to 20 carbon atoms, more preferably one having from 1 to 16 carbon atoms, and especially preferably one having from 1 to 12 carbon atoms; for example, a methanesulfinyl group, a benzenesulfinyl group, etc.), a ureido group (preferably one having from 1 to 20 carbon atoms, more preferably one having from 1 to 16 carbon atoms, and especially preferably one having from 1 to 12 carbon atoms; for example, a ureido group, a methyl ureido group, a phenyl ureido group, etc.), a phosphoric acid amide group (preferably one having from 1 to 20 carbon atoms, more preferably one having from 1 to 16 carbon atoms, and especially preferably one having from 1 to 12 carbon atoms; for example, a diethylphosphoric acid amide group, a phenylphosphoric acid amide group, etc.), a hydroxyl group, a mercapto group, a halogen atom (for example, a fluorine atom, a chlorine atom, a bromine atom or an iodine atom), a cyano group, a sulfo group, a carboxyl group, a nitro group, a hydroxamic acid group, a sulfino group, a hydrazino group, an imino group, a heterocyclic group (preferably one having from 1 to 30 carbon atoms, and more preferably one having from 1 to 12 carbon atoms; examples of the hetero atom include a nitrogen atom, an oxygen atom and a sulfur atom; and specific example of the heterocyclic group include an imidazolyl group, a pyridyl group, a quinolyl group, a furyl group, a piperidyl group, a morpholino group, a benzoxazolyl group, a benzimidazolyl group and a benzothiazolyl group) and a silyl group (preferably one having from 3 to 40 carbon atoms, more preferably one having from 3 to 30 carbon atoms, and especially preferably one having from 3 to 24 carbon atoms; for example, a trimethylsilyl group, a triphenylsilyl group, etc.). Such a substituent may be further substituted. Also, when two or more substituents are existent, each substituent may be the same as or different from every other substituent(s). Also, if possible, these substituents may be connected to each other to form a ring.

In the formula (1), R² represents an alkyl group, an alkenyl group, an alkynyl group, an aryl group or a heterocyclic group. From the viewpoints of improving the humidity dependency and improving the redissolution properties, R² is preferably an alkyl group or an aryl group. Here, in amino resins which have hitherto been generally used, polycondensation was performed by so-called methylol connection via formaldehyde. That is, it was general that in the formula (1), R² is a hydrogen atom. In the invention, it has been found that when R² in the formula (1) is changed from the hydrogen atom to an alkyl group, an alkenyl group, an alkynyl group, an aryl group or a heterocyclic group, solubility in an organic solvent, particularly solubility in a solvent composed of a combination of a chlorine based solvent such as methylene chloride and an alcohol, and more particularly solubility in methylene chloride/methanol is conspicuously increased, leading to accomplishment of the invention. Such a polymer (amino resin) having a repeating unit represented by the formula (1) has not been substantially used so far because formaldehyde is relatively inexpensive as compared with other aldehydes, and reactivity of the methylol connection using formaldehyde is high. Also, the polymer having a repeating unit represented by the formula (1) has not been used in the optical film field.

When R² is an alkyl group, the alkyl group is preferably one having from 1 to 20 carbon atoms, more preferably one having from 1 to 12 carbon atoms, and especially preferably one having from 1 to 8 carbon atoms.

When R² is an alkenyl group, the alkenyl group is preferably one having from 2 to 20 carbon atoms, more preferably one having from 3 to 15 carbon atoms, and especially preferably one having from 6 to 12 carbon atoms.

When R² is an alkynyl group, the alkynyl group is preferably one having from 2 to 20 carbon atoms, more preferably one having from 3 to 15 carbon atoms, and especially preferably one having from 6 to 12 carbon atoms.

When R² is an aryl group, the aryl group is preferably one having from 6 to 24 carbon atoms, more preferably one having from 6 to 18 carbon atoms, and especially preferably one having 6 carbon atoms from the viewpoint of improving the humidity dependency.

When R² is a heterocyclic group, the heterocyclic group is preferably one having from 4 to 23 carbon atoms, more preferably one having from 4 to 17 carbon atoms, and especially preferably one having 5 carbon atoms from the viewpoint of improving the humidity dependency.

R² may further have a substituent or may not have a substituent, and examples of the substituent include the foregoing substituents T.

(Weight Average Molecular Weight of the Polymer having a Repeating Unit Represented by the Formula (1))

The polymer having a repeating unit represented by the formula (1) has a weight average molecular weight of preferably from 500 to 10,000, more preferably from 1,000 to 5,000, and especially preferably from 1,000 to 3,000. In this connection, the weight average molecular weight can be determined by comparison with a molecular weight reference material of polystyrene by means of GPC measurement (reduced to polystyrene) with N-methyl-2-pyrrolidone as a solvent using “HLC-8120GPC”, manufactured by Tosoh Corporation.

Also, the polymer having a repeating unit represented by the formula (1) is low in volatility at the time of film formation as compared with low-molecular weight compounds such as benzoguanamine and is preferable from the viewpoint of preservation of manufacturing apparatus. In particular, when heated (particularly, heated at 180° C. or higher) in a stretching step in a manufacturing method of the cellulose acylate film of the invention as described later, the polymer having a repeating unit represented by the formula (1) is more preferable than the low-molecular weight compounds.

In this connection, though a polymerization degree of the polymer having a repeating unit represented by the formula (1) is not particularly limited, dimers to tricontamers are preferable, trimers to eicosamers are more preferable, and tetramers to decamers are especially preferable.

(Addition Amount of the Polymer having a Repeating Unit Represented by the Formula (1))

An addition amount of the polymer having a repeating unit represented by the formula (1) is preferably not more than 50% by mass, more preferably from 0.5 to 30% by mass, still more preferably from 2 to 20% by mass, and yet still more preferably from 3 to 15% by mass relative to the cellulose acylate film. In this way, the polymer having a repeating unit represented by the formula (1) is able to sufficiently improve the humidity dependency through the use with a smaller amount as compared with humidity dependency improvers which have been reported so far.

(Manufacturing Method of the Polymer having a Repeating Unit Represented by the Formula (1))

A manufacturing method of the polymer having a repeating unit represented by the formula (1) which is contained in the cellulose acylate film of the invention is not particularly limited, and the polymer having a repeating unit represented by the formula (1) can be manufactured by known methods. Above all, it is preferable that the polymer having a repeating unit represented by the formula (1) is synthesized according to a manufacturing method of the cellulose acylate film of the invention as described later.

### <Cellulose Acylate>

The cellulose acylate film of the invention contains a cellulose acylate. The cellulose acylate which can be preferably used for the film of the invention is hereunder described.

It is preferable that the film of the invention contains, as a main component, a cellulose acylate. With respect to the terms “contains, as a main component,” as referred to herein, in the case where the cellulose acylate used as a material of the cellulose acylate film is a single kind, then the subject cellulose acylate is meant; and in the case where plural kinds of cellulose acylates are used, then a cellulose acylate contained in the highest proportion is meant. The cellulose has free hydroxyl groups at the 2-, 3- and 6-positions per glucose unit having a β-1,4-bond.

Examples of the cellulose which is used as a raw material of the cellulose acylate include cotton linter and wood pulps (for example, hardwood pulps and soft wood pulps), and cellulose acylates obtained from any of these raw material celluloses can be used. As the case may be, a mixture thereof may be used. These raw material celluloses are described in detail in, for example, Course of Plastic Materials (17): Cellulose Resins (written by Marusawa and Uda and published by The Nikkan Kogyo Shimbun, Ltd. (1970)); and Journal of Technical Disclosure, No. 2001-1745 (pages 7 to 8) by Japan Institute of Invention and Innovation. But, it should be construed that the cellulose acylate film is not particularly limited thereto.

In the cellulose acylate film, though the acyl group of the cellulose acylate is not particularly limited, an acetyl group, a propionyl group or a butyryl group is preferable, and an acetyl group is more preferable.

A total degree of acyl substitution of the cellulose acylate is preferably from 1.5 to 3, more preferably from 1.8 to 3, and especially preferably from 2.0 to 3.

Specifically, it is preferable to contain a cellulose acylate satisfying the following expressions (i) to (iii) at the same time.

2.0≦(A+B)≦3 Expression (i)

1.0≦A≦3 Expression (ii)

0≦B≦1.0 Expression (iii)

In the expressions (i) to (iii), A represents a degree of substitution of an acetyl group; and B represents a total sum of a degree of substitution of a propionyl group and a degree of substitution of a butyryl group.

When a cellulose acylate satisfying the expression (i) and having (A+B) of 2.0 or more is used, since the hydrophilicity becomes low to some extent, not only the cellulose acylate is easily soluble in methylene chloride which is preferably used as the solvent for dissolving it therein, but the film becomes stable under a usual humidity.

In the cellulose acylate film, it is more preferable that the degree of acyl substitution of the cellulose acylate satisfies the following expressions (iv) to (vi) at the same time.

2.0≦(A+B)≦3 Expression (iv)

1.5≦A≦3 Expression (v)

B=0 Expression (vi)

In the expressions (iv) to (vi), A represents a degree of substitution of an acetyl group; and B represents a total sum of a degree of substitution of a propionyl group and a degree of substitution of a butyryl group.

The degree of acetyl substitution, the degree of propionyl substitution and the degree of butyryl substitution in the cellulose acylate mean proportions at which three hydroxyl groups existent in the constituent unit of the cellulose (glucose having (β)1,4-glycoside bond) are acetylated and propionylated and/or butyrylated, respectively. In this connection, in this specification, the degree of substitution of each of the acetyl group, the propionyl group and the butyryl group of the cellulose acylate can be calculated by measuring a linked fatty acid amount per constituent unit mass of the cellulose. The measurement method is carried out according to “ASTM D817-91”.

The cellulose acylate preferably has a mass average polymerization degree of from 350 to 800, and more preferably has a mass average polymerization degree of from 370 to 600. Also, the cellulose acylate which is used in the invention preferably has a number average molecular weight of from 70,000 to 230,000, more preferably has a number average molecular weight of from 75,000 to 230,000, and still more preferably has a number average molecular weight of from 78,000 to 120,000.

### (Synthesis Method of Cellulose Acylate)

The cellulose acylate can be synthesized using, as an acylating agent, an acid anhydride or an acid chloride. The most industrially general synthesis method is as follows. The desired cellulose acylate can be synthesized by esterifying a cellulose obtained from cotton linter, wood pulp or the like with a mixed organic acid component containing an organic acid (for example, acetic acid, propionic acid or butyric acid) or an acid anhydride thereof (for example, acetic anhydride, propionic anhydride or butyric anhydride), which is corresponding to an acetyl group, a propionyl group and/or a butyryl group.

(Existent Embodiment of the Cellulose Acylate and the Polymer having a Repeating Unit Represented by the Formula (1) in the Film)

In the film of the invention, it is preferable that the cellulose acylate does not form a crosslinking structure with the polymer having a repeating unit represented by the formula (1). Specifically, it is preferable that the hydroxyl groups of the cellulose constituting the cellulose acylate are substituted with only an acyl group. In this way, what the cellulose acylate and the polymer having a repeating unit represented by the formula (1) do not crosslink with each other in the film is preferable because the solubility of the cellulose acylate film in an organic solvent can be increased.

### <Other Additives>

The cellulose acylate film of the invention may contain other additive than the polymer having a repeating unit represented by the formula (1) depending upon various purposes. In the case of manufacturing the cellulose acylate film by means of solution film formation, such an additive can be added in a polymer resin dope, for example, a cellulose acylate dope. Timing of the addition is not particularly limited. The additive is selected from agents which are compatible (soluble in the cellulose acylate dope in the solution film formation) with a polymer (for example, a cellulose acylate). The additive is added for the purposes of adjusting optical characteristics of the cellulose acylate film and adjusting other characteristics and the like.

### (Plasticizer)

Since the cellulose acylate film of the invention contains a plasticizer, it is improved in film forming properties and the like, so that such is preferable. When a sugar based plasticizer selected from a group of compounds consisting of sugars and derivatives thereof, or an oligomer based plasticizer selected from oligomers composed of polycondensed esters of a dicarboxylic acid and a diol and derivatives thereof is used as the plasticizer, the resistance to environmental humidity of the cellulose acylate film is improved, and hence, such is preferable. Specifically, fluctuations in Rth dependent upon the humidity can be reduced. When both of the sugar based plasticizer and the oligomer based plasticizer are used in combination, an effect for reducing fluctuations in Rth dependent upon the humidity is increased.

### (Sugar Based Plasticizer)

As described above, it is preferable that the cellulose acylate film of the invention contains at least one compound selected from a group of compounds consisting of sugars and derivatives thereof. Above all, a compound selected from a group of compounds consisting of monomeric to decameric sugars and derivatives thereof is preferable as the plasticizer. Examples thereof include sugar derivatives obtained by substituting a part or the whole of hydrogen atoms in OH of a sugar such as glucose with an acyl group, as described in paragraphs [0042] to [0065] of WO2007/125764. An addition amount of the sugar based plasticizer is preferably 0.1% by mass or more and less than 20% by mass, more preferably 0.1% by mass or more and less than 10% by mass, and still more preferably 0.1% by mass or more and less than 7% by mass relative to the cellulose acylate that is a main component.

### (Oligomer Based Plasticizer)

As described above, it is preferable that the cellulose acylate film of the invention contains an oligomer based plasticizer selected from oligomers. Preferred examples of the oligomer based plasticizer include polycondensed esters of a diol component and a dicarboxylic acid component and derivatives thereof (hereinafter also referred to as “polycondensed ester based plasticizer”); and oligomers of methyl acrylate (MA) and derivatives thereof (hereinafter also referred to as “MA oligomer based plasticizer”).

The polycondensed ester is a polycondensed ester of a dicarboxylic acid component and a diol component. The dicarboxylic acid component may be composed of a single dicarboxylic acid or may be a mixture of two or more dicarboxylic acids. Above all, it is preferable to use, as the dicarboxylic acid component, a dicarboxylic acid component containing at least one aromatic dicarboxylic acid and at least one aliphatic dicarboxylic acid. Meanwhile, the diol component may also be composed of a single diol component or may be a mixture of two or more diols. Above all, it is preferable to use, as the diol component, ethylene glycol and/or an aliphatic diol having an average carbon atom number of more than 2.0 and not more than 3.0.

It is preferable that a ratio of the aromatic dicarboxylic acid and the aliphatic dicarboxylic acid in the dicarboxylic acid component is from 5 to 70% by mole in terms of the aromatic dicarboxylic acid. When the ratio of the aromatic dicarboxylic acid in the dicarboxylic acid component falls within the foregoing range, not only the environmental humidity dependency of optical characteristics of the film can be reduced, but the generation of bleedout in a film formation process can be suppressed. The ratio of the aromatic dicarboxylic acid in the dicarboxylic acid component is more preferably from 10 to 60% by mole, and still more preferably from 20 to 50% by mole.

Examples of the aromatic dicarboxylic acid include phthalic acid, terephthalic acid, isophthalic acid, 1,5-naphthalenedicarboxylic acid, 1,4-naphthalenedicarboxylic acid, 1,8-naphthalenedicarboxylic acid, 2,8-naphthalenedicarboxylic acid and 2,6-naphthalenedicarboxylic acid, with phthalic acid and terephthalic acid being preferable. Examples of the aliphatic dicarboxylic acid include oxalic acid, malonic acid, succinic acid, maleic acid, fumaric acid, glutaric acid, adipic acid, pimelic acid, suberic acid, azelaic acid, sebacic acid, dodecanedicarboxylic acid and 1,4-cyclohexanedicarboxylic acid, with succinic acid and adipic acid being preferable.

The diol component is ethylene glycol and/or a diol having an average carbon number of more than 2.0 and not more than 3.0. A proportion of ethylene glycol in the diol component is preferably 50% by mole or more, and more preferably 75% by mole or more. As the aliphatic diol, alkyl diols or alicyclic diols can be exemplified. Examples thereof include ethylene glycol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethyloheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol and diethylene glycol. It is preferable that such a diol is used singly or in admixture of two or more kinds thereof together with ethylene glycol.

The diol component is preferably ethylene glycol, 1,2-propanediol or 1,3-propanediol, and especially preferably ethylene glycol or 1,2-propanediol.

Also, the polycondensed ester based plasticizer is preferably a derivative of the polycondensed ester in which OH at each terminal of the polycondensed ester forms an ester together with a monocarboxylic acid. As the monocarboxylic acid which is used for sealing the OH group at each terminal, aliphatic monocarboxylic acids are preferable; acetic acid, propionic acid, butanoic acid, benzoic acid and derivatives thereof are more preferable; acetic acid and propionic acid are still more preferable; and acetic acid is the most preferable. When the carbon number of the monocarboxylic acid used at each terminal of the polycondensed ester is not more than 3, a heating loss of the compound does not become large, and it is possible to reduce the generation of a failure in surface properties. Also, the monocarboxylic used for sealing may be a mixture of two or more kinds thereof. It is preferable that each terminal of the polycondensed ester is sealed with acetic acid or propionic acid, and a derivative of a polycondensed ester in which each terminal thereof is an acetyl ester residue by means of sealing with acetic acid is especially preferable.

The polycondensed ester and its derivative are preferably an oligomer having a number average molecular weight of from about 700 to 2,000. The number average molecular weight is more preferably from about 800 to 1,500, and still more preferably from about 900 to 1,200. In this connection, the number average molecular weight of the polycondensed ester can be measured and evaluated by means of gel permeation chromatography.

Specific examples of the polycondensed ester based plasticizer are shown in the following Table 1, but it should not be construed that the invention is limited thereto.

TABLE 1

| | Dicarboxylic acid *¹⁾ | | | Diol | | | | |
|---|---|---|---|---|---|---|---|---|
| | Aromatic | Aliphatic | Dicarboxylic | | | Average carbon | | |
| | dicarboxylic | dicarboxylic | acid ratio | | Diol ratio | number of | | Number average |
| | acid | acid | (% by mole) | Aliphatic diol | (% by mole) | aliphatic diol | Both terminals | molecular weight |
| p-1 | PA | AA | 10/90 | Ethylene glycol | 100 | 2.0 | Acetyl ester residue | 1000 |
| P-2 | PA | AA | 25/75 | Ethylene glycol | 100 | 2.0 | Acetyl ester residue | 1000 |
| P-3 | PA | AA | 50/50 | Ethylene glycol | 100 | 2.0 | Acetyl ester residue | 1000 |
| P-4 | PA | SA | 5/95 | Ethylene glycol | 100 | 2.0 | Acetyl ester residue | 1000 |
| P-5 | PA | SA | 20/80 | Ethylene glycol | 100 | 2.0 | Acetyl ester residue | 1000 |
| P-6 | TPA | AA | 15/85 | Ethylene glycol | 100 | 2.0 | Acetyl ester residue | 1000 |
| P-7 | TPA | AA | 50/50 | Ethylene glycol | 100 | 2.0 | Acetyl ester residue | 1000 |
| P-8 | TPA | SA | 5/95 | Ethylene glycol | 100 | 2.0 | Acetyl ester restdue | 1000 |
| P-9 | TPA | SA | 10/90 | Ethylene glycol | 100 | 2.0 | Acetyl ester residue | 1000 |
| P-10 | TPA | SA | 15/85 | Ethylene glycol | 100 | 2.0 | Acetyl ester residue | 1000 |
| p-11 | TPA | SA | 50/50 | Ethylene glycol | 100 | 2.0 | Acetyl ester residue | 1000 |
| p-12 | TPA | SA | 70/30 | Ethylene glycol | 100 | 2.0 | Acetyl ester residue | 1000 |
| P-13 | TPA/PA | AA | 10/10/80 | Ethylene glycol | 100 | 2.0 | Acetyl ester residue | 1000 |
| P-14 | TPA/PA | AA | 20/20/60 | Ethylene glycol | 100 | 2.0 | Acetyl ester residue | 1000 |
| P-15 | TPA/PA | AA/SA | 10/10/40/40 | Ethylene glycol | 100 | 2.0 | Acetyl ester residue | 1000 |
| P-16 | TPA | AA/SA | 10/30/60 | Ethylene glycol | 100 | 2.0 | Acetyl ester residue | 1000 |
| P-17 | TPA | AA/SA | 10/30/60 | Ethylene glycol/ | 50/50 | 2.5 | Acetyl ester residue | 1000 |
| | | | | 1,2-propanediol | | | | |
| P-18 | TPA | AA/SA | 10/30/60 | 1,2-Propanediol | 100 | 3.0 | Acetyl ester residue | 1000 |
| P-19 | TPA | AA/SA | 10/30/60 | Ethylene glycol | 100 | 2.0 | Acetyl ester residue | 700 |
| P-20 | TPA | AA/SA | 10/30/60 | Ethylene glycol | 100 | 2.0 | Acetyl ester residue | 850 |
| P-21 | TPA | AA/SA | 10/30/60 | Ethylene glycol | 100 | 2.0 | Acetyl ester residue | 1200 |
| P-22 | TPA | AA/SA | 10/30/60 | Ethylene glycol | 100 | 2.0 | Acetyl ester residue | 1600 |
| P-23 | TPA | AA/SA | 10/30/60 | Ethylene glycol | 100 | 2.0 | Acetyl ester residue | 2000 |
| P-24 | TPA | AA/SA | 10/30/60 | Ethylene glycol | 100 | 2.0 | Propionyl ester | 1000 |
| | | | | | | | residue | |
| P-25 | TPA | AA/SA | 10/30/60 | Ethylene glycol | 100 | 2.0 | Butanoyl ester residue | 1000 |
| P-26 | TPA | AA/SA | 10/30/60 | Ethylene glycol | 100 | 2.0 | Benzoyl ester residue | 1000 |
| P-27 | IPA | AA/SA | 20/40/40 | Ethylene glycol | 100 | 2.0 | Acetyl ester residue | 1000 |
| P-28 | 2,6-NPA | AA/SA | 20/40/40 | Ethylene glycol | 100 | 2.0 | Acetyl ester residue | 1200 |
| p-29 | 1,5-NPA | AA/SA | 20/40/40 | Ethylene glycol | 100 | 2.0 | Acetyl ester residue | 1200 |
| P-30 | 1,4-NPA | AA/SA | 20/40/40 | Ethylene glycol | 100 | 2.0 | Acetyl ester residue | 1200 |
| P-31 | 1,8-NPA | AA/SA | 20/40/40 | Ethylene glycol | 100 | 2.0 | Acetyl ester residue | 1200 |
| P-32 | 2,8-NPA | AA/SA | 20/40/40 | Ethylene glycol | 100 | 2.0 | Acetyl ester residue | 1200 |

*¹⁾ PA: Phthalic acid, TPA: Terephthalic acid, IPA: Isophthalic acid, AA: Adipic acid, SA: Succinic acid, 2,6-NPA: 2,6-Naphthalenedicarboxylic acid, 2,8-NPA: 2,8-Naphthalenedicarboxylic acid, 1,5-NPA: 1,5-Naphthalenedicarboxylic acid, 1,4-NPA: 1,4-Naphthalenedicarboxylic acid, 1,8-NPA: 1,8-Naphthalenedicarboxylic acid

The polycondensed ester can be easily synthesized by any method of a hot melt condensation method by a polyesterification reaction or ester interchange reaction between a dicarboxylic acid component and a diol component, or an interfacial condensation method between an acid chloride that is a dicarboxylic acid component and a glycol in the usual way. Also, the polycondensed ester according to the invention is described in detail in Koichi Murai Ed., Plasticizer—Theory and Application (the First Edition, the First Print, published by Saiwai Shobo, Mar. 1, 1973). Also, raw materials described in JP-A-05-155809, JP-A-05-155810, JP-A-5-197073, JP-A-2006-259494, JP-A-07-330670, JP-A-2006-342227, JP-A-2007-003679, etc. can be utilized.

An addition amount of the polycondensed ester based plasticizer is preferably from 0.1 to 25% by mass, more preferably from 1 to 20% by mass, and most preferably from 3 to 15% by mass relative to the cellulose acylate that is a main component.

A content of the raw materials and by-products contained in the polycondensed ester based plasticizer, specifically an aliphatic diol, a dicarboxylic acid ester, a diol ester and so on, is preferably less than 1% by mass, and more preferably less than 0.5% by mass in the film. Examples of the dicarboxylic acid ester include dimethyl phthalate, di(hydroxyethyl)phthalate, dimethyl terephthalate, di(hydroxyethyl)terephthalate, di(hydroxyethyl)adipate and di(hydroxyethyl)succinate. Examples of the diol ester include ethylene diacetate and propylene diacetate.

As the plasticizer which is used for the cellulose acylate film of the invention, a methyl methacrylate (MA) oligomer based plasticizer is also preferable. A combined use of the MA oligomer based plasticizer and the sugar based plasticizer is also preferable. In an embodiment of the combined use, the MA oligomer based plasticizer and the sugar based plasticizer are used in a proportion of preferably from 1/2 to 1/5, and more preferably from 1/3 to 1/4 in terms of a mass ratio. An example of the MA oligomer based plasticizer is an oligomer containing the following repeating unit.

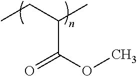

A weight average molecular weight of the oligomer containing the foregoing repeating unit is preferably from about 500 to 2,000, more preferably from about 700 to 1,500, and still more preferably from about 800 to 1,200.

Also, the MA oligomer based plasticizer may be, in addition to an oligomer composed of MA alone, an oligomer having not only the foregoing repeating unit derived from MA but at least one repeating unit derived from other monomers. Examples of other monomers include ethyl acrylate, propyl (i- or n-) acrylate, butyl (n-, s- or t-) acrylate, pentyl (n-, i- or s-) acrylate, hexyl (n- or i-) acrylate, heptyl (n- or i-) acrylate, octyl (n- or i-) acrylate, nonyl (n- or i-) acrylate, myristyl (n- or i-) acrylate, 2-ethylhexyl acrylate, ε-caprolactone acrylate, 2-hydroxyethyl acrylate, 2-hydroxypropyl acrylate, 3-hydroxypropyl acrylate, 4-hydroxybutyl acrylate, 2-hydroxybutyl acrylate, 2-methoxyethyl acrylate and 2-ethoxyethyl acrylate, and monomers obtained by replacing the foregoing acrylic acid esters by methacrylic acid esters. Also, monomers having an aromatic ring such as styrene, methylstyrene and hydroxystyrene can be utilized. As other monomers, aromatic ring-free acrylic acid ester monomers and methacrylic acid ester monomers are preferable.

Also, in the case where the MA oligomer based plasticizer is an oligomer having two or more repeating units, oligomers composed of X (monomer component having a hydrophilic group) and Y (monomer component not having a hydrophilic group) in a molar ratio of X/Y, of from 1/1 to 1/99 are preferable.

Such an MA based oligomer can be synthesized by referring to a method described in JP-A-2003-12859.

### (Polymer Plasticizer)

The cellulose acylate film of the invention may contain other polymer based plasticizer together with or in place of the foregoing sugar based plasticizer, polycondensed ester based plasticizer and MMA oligomer based plasticizer. Examples of other polymer based plasticizer include polyester polyurethane based plasticizers, aliphatic hydrocarbon based polymers, alicyclic hydrocarbon based polymers, polyvinyl isobutyl ether, vinyl based polymers such as poly-N-vinylpyrrolidone, a styrene based polymer such as polystyrene and poly-4-hydroxystyrene, polyethers such as polyethylene oxide and polypropylene oxide, polyamides, polyurethanes, polyureas, a phenol-formaldehyde condensate, a urea-formaldehyde condensate and polyvinyl acetate.

(Compound having at Least Two Aromatic Rings)

The cellulose acylate film of the invention may contain a compound having at least two aromatic rings so far as the gist of the invention is not deviated. The subject compound has an action for adjusting optical characteristics of the cellulose acylate film. For example, in the case where the cellulose acylate film of the invention is used as an optically compensatory film, in order to control optical characteristics, especially Re to preferred values, stretching is effective. For the purpose of raising the Re, it is necessary to increase the refractive index anisotropy within the film plane, and one method thereof is to enhance the alignment of a principal chain of the film by stretching. Also, by using a compound with large refractive index anisotropy as an additive, it is possible to further raise the refractive index anisotropy of the film. For example, in the foregoing compound having at least two aromatic rings, the polymer principal chain is arranged due to stretching, and following this, the alignment properties of the compound are enhanced, whereby it becomes easy to control the desired optical characteristics.

Examples of the compound having at least two aromatic rings include triazine compounds described in JP-A-2003-344655; rod-shaped compounds described in JP-A-2002-363343; and liquid crystalline compounds described in JP-A-2005-134884 and JP-A-2007-119737. Of these, the foregoing triazine compounds or rod-shaped compounds are more preferable. The compound having at least two aromatic rings can also be used in combination of two or more kinds thereof. In this connection, a molecular weight of the compound having at least two aromatic rings is preferably from about 300 to 1,200, and more preferably from 400 to 1,000.

An addition amount of the compound having at least two aromatic rings is preferably from 0.05% to 10%, more preferably from 0.5% to 8%, and still more preferably from 1% to 5% in terms of a mass ratio relative to the cellulose acylate. Also, the compound having at least two aromatic rings may also serve as the compound represented by the formula (1) or (2) which is used in the invention. Meanwhile, in the case where while the compound having two aromatic rings has a 1,3,5-triazine ring structure, it does not satisfy the formula (1) or (2), from the viewpoint of improving the humidity dependency, an addition amount of the subject compound having two aromatic rings is preferably from 0.05% to 10%, more preferably from 0.5% to 8%, and especially preferably from 1% to 5% in terms of amass ratio relative to the cellulose acylate.

### (Optical Anisotropy Adjusting Agent)

Also, the cellulose acylate film of the invention may contain an optical anisotropy adjusting agent. For example, mention may be made of the “compounds for reducing Rth” described on pages 23 to 72 of JP-A-2006-30937 as examples.

### (Mat Agent Fine Particle)

To the cellulose acylate film, a mat agent may be added. Examples of fine particles which are used as the mat agent include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. As the fine particles, ones containing silicon are preferable from the standpoint of low turbidity, and silicon dioxide is especially preferable.

As the fine particles of silicon dioxide, there can be used commercially available products such as AEROSIL R972, R972V, R974, R812, 200, 200V, 300, R202, OX50 and TT600 (all of which are manufactured by Nippon Aerosil Co., Ltd.). The fine particles of zirconium oxide are commercially available under trade names of AEROSIL R976 and R811 (all of which are manufactured by Nippon Aerosil Co., Ltd.), and they are usable.

For a manufacturing method of a cellulose acylate film having particles with a small secondary average particle size, a liquid dispersion of fine particles can be used. For example, when the cellulose acylate film is referred to as an example, some techniques maybe considered at the preparation of a liquid dispersion of fine particles. For example, there is a method in which a fine particle liquid dispersion obtained by stirring and mixing a solvent and fine particles is previously formed; the fine particle liquid dispersion is added to a small amount of a separately prepared cellulose acylate solution, and dissolved therein with stirring; and the resulting solution is further mixed with a main cellulose acylate dope solution. This method is a preferable preparation method from the standpoints that the dispersibility of silicon dioxide fine particles is good and that silicon dioxide fine particles are less likely to further aggregate again. Besides, there is another method in which a small amount of a cellulose acylate is added to a solvent and dissolved therein with stirring; fine particles are then added thereto and dispersed therein using a dispersing machine to form a fine particle-added solution; and this fine particle-added solution is sufficiently mixed with a dope solution using an inline mixer. Any of these methods may be utilized. Also, it should not be construed that the invention is limited to these methods.

As the solvent to be used for the foregoing preparation methods, a lower alcohol is useful. Preferred examples thereof include methyl alcohol, ethyl alcohol, propyl alcohol, isopropyl alcohol and butyl alcohol. Though other solvents than the lower alcohol are not particularly limited, it is preferable to use the solvent which is used for the film formation of the cellulose acylate.

### (Low-Molecular Weight Plasticizer, Deterioration Inhibitor and Release Agent)

To the cellulose acylate film, various additives (for example, a low-molecular weight plasticizer, an ultraviolet absorber, a deterioration inhibitor, a release agent, an infrared absorber, etc.) according to an application in each preparation step can be added, and they may be each either a solid or an oily material. That is, there are no particular limitations on a melting point or boiling point. For example, mention may be made of mixing of ultraviolet absorbing materials of not higher than 20° C. and 20° C. or higher, and similarly, mixing of a plasticizer. For example, they are described in JP-A-2001-151901 or the like. Moreover, infrared absorbing dyes are described in, for example, JP-A-2001-194522. Also, with respect to timing of the addition, the additives may be added at any timing in the dope preparation process. However, a step of adding the additives for preparation at final timing in the dope preparation process may be added. Still further, an addition amount of each material is not particularly limited so far as it allows the function to be revealed. Also, in the case where the cellulose acylate film is formed of multiple layers, the type and addition amount of additives for each layer may be different. Although these are described in, for example, JP-A-2001-151902, these are conventionally known techniques. For the details thereof, materials described in detail in Journal of Technical Disclosure, No. 2001-1745, pages 16 to 22, issued on Mar. 15, 2001 by Japan Institute of Invention and Innovation are preferably useful.

### <Various Characteristics of Cellulose Acylate Film>

### (Re and Rth)

Preferred ranges of optical characteristics of the cellulose acylate film of the invention vary depending upon an application. In an embodiment to be utilized for a liquid crystal display device of a VA mode, it is preferable that Re(589) is from 30 nm to 200 nm and that Rth(589) is from 70 nm to 400 nm; it is more preferable that Re(589) is from 30 nm to 150 nm and that Rth(589) is from 100 nm to 300 nm; and it is still more preferable that Re(589) is from 40 nm to 100 nm and that Rth(589) is from 100 nm to 250 nm.

In this specification, Re(λ) and Rth(λ) represent an in-plane retardation (nm) and a retardation (nm) in a thickness direction at a wavelength of λ, respectively. Re(λ) is measured by making light having a wavelength of λ nm incident in a normal direction of the film in KOBRA 21ADH or WR (manufactured by Oji Scientific Instruments).

In the case where the film to be measured is expressed by a uniaxial or biaxial refractive index ellipsoid, Rth(λ) is calculated according to the following method.

Rth(λ) is calculated by KOBRA 21ADH or WR on the basis of the foregoing Re(λ); retardation values at six points in total measured by making light having a wavelength of λ nm incident in the normal direction and directions inclined to 50° on one side at an interval of 10° over the normal direction of the film with the in-plane slow axis (determined by KOBRA 21 ADH or WR) as an inclined axis (rotation axis) (or with an arbitrary direction in the film plane as a rotation axis when there is no slow axis); a hypothesized value of average refractive index; and an inputted film thickness value.

In the foregoing, in the case where the film has a retardation value of zero in a direction at a certain inclined angle over the normal direction with the in-plane slow axis as a rotation axis, the retardation value at a larger inclined angle than the foregoing inclined angle is calculated by KOBRA 21ADH or WR, after the sign of the retardation value is converted negative.

In this connection, Rth can also be calculated by the following expressions (X) and (XI) on the basis of: retardation values measured from arbitrary inclined two directions, with the slow axis as an inclined axis (a rotation axis) (or with the in-plane arbitrary direction as a rotation axis when there is no slow axis); a hypothesized value of average refractive index; and an inputted film thickness value.

$$\begin{matrix}Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & Expression ( X ) \\ Rth = \{ ( nx + ny ) / 2 - nz \} \times d & Expression ( XI )\end{matrix}$$

In the foregoing expressions, Re(θ) represents a retardation value in the direction inclined by an angle θ from the normal direction; nx represents a refractive index in the slow axis direction in the plane; ny represents a refractive index in the direction orthogonal to nx in the plane; nz represents a refractive index in the direction orthogonal to nx and ny; and d represents a film thickness.

In the case where the film to be measured cannot be expressed by a uniaxial or biaxial refractive index ellipsoid, i.e., a film having no so-called optic axis, Rth(λ) is calculated as follows.

Rth(λ) is calculated by KOBRA 21ADH or WR on the basis of the foregoing Re(λ); retardation values measured at eleven points by making light having a wavelength λ nm incident in the directions inclined to −50° to +50° at an interval of 10° over the normal direction of the film with the in-plane slow axis (determined by the KOBRA 21ADH or WR) as an inclined axis (a rotation axis); a hypothesized value of average refractive index; and an inputted film thickness value.

In the foregoing measurement, as the hypothesized value of average refractive index, values described in Polymer Handbook (John Wiley & Sons, Inc.) and catalogues of various optical films can be employed. When a value of average refractive index is not known, it can be measured by an ABBE's refractometer. Values of average refractive index of major optical films are enumerated as follows: cellulose acylate (1.48), cycloolefin polymer (1.52), polycarbonate (1.59), polymethyl methacrylate (1.49) and polystyrene (1.59).

By inputting such a hypothesized value of average refractive index and a film thickness, nx, ny and nz are calculated by KOBRA 21ADH or WR. Nz=(nx−nz)/(nx−ny) is further calculated from the thus calculated nx, ny and nz.

In the invention, the “slow axis” of a retardation film or the like means a direction in which the refractive index is a maximum. Also, a measuring wavelength of the refractive index is a value at λ=589 nm in a visible light region unless otherwise indicated.

### (Humidity Dependency of Re and Humidity Dependency of Rth)

In the cellulose acylate film of the invention, fluctuations in Re and Rth at the time of humidity control at 25° C. and a relative humidity of 10% for 12 hours (also referred to as “Re(10%)” and “Rth(10%)”, respectively) and in Re and Rth at the time of humidity control at 25° C. and a relative humidity of 80% for 12 hours (also referred to as “Re(80%) ” and “Rth(80%)”, respectively) are small. By enhancing the humidity dependency of optical characteristics in this way, it is possible to obtain a polymer which is suppressed in fluctuations in Re and Rth even under a condition under which the humidity of the use environment is changed, is able to exhibit a retardation of the foregoing preferred range and is suitable for use under a condition under which the humidity of the use environment is changed, in particular, a cellulose acylate film.

In the cellulose acylate film of the invention, the humidity dependency of Re (ΔRe=Re(10%)−Re(80%)) is preferably less than 15 nm, more preferably not more than 10 nm, and especially preferably not more than 9 nm.

In the cellulose acylate film of the invention, the humidity dependency of Rth (ΔRth=Rth(10%)−Rth(80%)) is preferably not more than 30 nm, more preferably not more than 25 nm, especially preferably not more than 20 nm, and more especially preferably not more than 16 nm.

### (Film Thickness)

In an embodiment in which the cellulose acylate film of the invention is utilized as a member of apparatus desired to be thinned, such as members of liquid crystal display devices, it is preferable that the film thickness is thinner. However, when the film thickness is too thin, optical characteristics required for such an application cannot be achieved. In an embodiment in which the cellulose acylate film of the invention is utilized as an optically compensatory film of liquid crystal display device or a polarizing plate protective film, the film thickness is preferably from about 20 to 80 μm. The film thickness is more preferably from about 25 to 70 μm, and still more preferably from about 30 to 60 μm.

### <Application of Cellulose Acylate Film>

The cellulose acylate film of the invention can be used for various applications. For example, the cellulose acylate film of the invention can be utilized for a retardation film of liquid crystal display device (hereinafter also referred to as “optically compensatory film”), a protective film of polarizing plate, a film for other application and the like.

Also, the cellulose acylate film of the invention can be used as an optically compensatory film by laminating a plural number of the cellulose acylate films of the invention or laminating the cellulose acylate film of the invention with a film falling outside the scope of the invention, thereby properly adjusting Re or Rth. The lamination of films can be carried out using a pressure sensitive adhesive or an adhesive.

### (Hard Coat Film, Antiglare Film and Anti-Reflection Film)

As the case may be, the cellulose acylate film of the invention may be applied to a hard coat film, an antiglare film or an anti-reflection film. For the purpose of enhancing the visibility of a flat panel display of LCD, PDP, CRT, EL or the like, any one or all of a hard coat layer, an antiglare layer and an anti-reflection layer can be provided on one or both surfaces of the cellulose acylate film of the invention. Desirable embodiments as such an antiglare film or antireflection film are described in detail in Journal of Technical Disclosure, No. 2001-1745, pages 54 to 57, issued on Mar. 15, 2001 by Japan Institute of Invention and Innovation, and those can be preferably adopted in the cellulose acylate film of the invention.

### [Retardation Film]

The cellulose acylate film of the invention can be used as a retardation film. In this connection, the “retardation film” or “optically compensatory film” as referred to herein means an optical material which is in general used for display devices such as liquid crystal display devices and which has optical anisotropy, and it is synonymous with an optically compensatory sheet or the like. In the liquid crystal display device, the optically compensatory film is used for the purpose of enhancing the contrast of display screen or improving a viewing angle characteristic or tint.

### [Manufacturing Method of Cellulose Acylate Film]

A manufacturing method of the cellulose acylate film of the invention (hereinafter also referred to as “manufacturing method of the invention”) includes a step of synthesizing a polymer by polycondensing a compound represented by the following formula (2) and a compound represented by the following formula (3) (provided that other compound may be used as a copolymerization component); a step of mixing the polymer with a cellulose acylate to prepare a dope; and a step of subjecting the dope to solution casting film formation to obtain a cellulose acylate film.

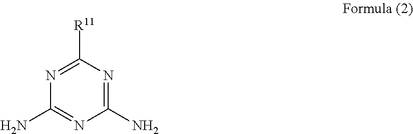

In the formula (2), R¹¹ represents an alkyl group having 2 or more carbon atoms, an alkenyl group, an alkynyl group, an aryl group or a heterocyclic group.

R¹²—CHO Formula (3)

In the formula (3), R¹² represents an alkyl group, an alkenyl group, an alkynyl group, an aryl group or a heterocyclic group.

### <Step of Synthesizing a Polymer>

First of all, a step of synthesizing the polymer having a repeating unit represented by the formula (1) is described. In the manufacturing method of the cellulose acylate film of the invention, the compound represented by the formula (2) and the compound represented by the formula (3) are polycondensed to synthesize a polymer. Conventionally, in the case of adding an amino resin to a cellulose acylate film, a precursor of the amino resin (compound before the polycondensation) was added to a cellulose acylate dope, followed by polycondensation or crosslinking. Different from the conventional method, the manufacturing method of the invention is characterized in that after once synthesizing the polymer (amino resin) having a repeating unit represented by the formula (1), the polymer is added to the cellulose acylate dope. In this way, by synthesizing the amino resin in advance and then adding it to the cellulose acylate dope, it is possible to prevent the occurrence of crosslinking between the amino resin and the cellulose acylate with each other. As a result, the resulting cellulose acylate film becomes favorable in solubility in an organic solvent, and hence, such is preferable.

### (Compound Represented by the Formula (2))

First of all, the compound represented by the formula (2) is described.

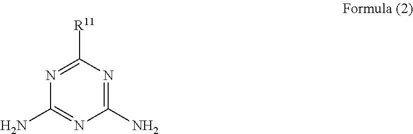

In the formula (2), R¹¹ represents an alkyl group having 2 or more carbon atoms, an alkenyl group, an alkynyl group, an aryl group or a heterocyclic group.

R¹¹ in the formula (2) is synonymous with R¹ in the formula (1), and a preferred range thereof is also the same.

A molecular weight of the compound represented by the formula (2) is preferably from 100 to 2,000, more preferably from 120 to 1,800, and especially preferably from 150 to 1,500.

With respect to a method of obtaining the compound represented by the formula (2), the compound can be obtained by means of synthesis or is commercially available. As the manufacturing method which is preferably adopted in the invention, for example, a method in which dicyanodiamide and a nitrile compound are heated in an alcohol in the presence of an inorganic base such as potassium hydroxide to form a triazine ring, as described in U.S. Pat. No. 3,478,026 and Chem. Eur. J., 2005, 11, 6616 to 6628; a method in which cyanuric chloride as a raw material is subjected to a displacement reaction with a Grignard compound and an amine compound step-by-step, as described in Tetrahedron, 2000, 56, 9705 to 9711; and a method in which a monoamino-disubstituted-s-triazine is synthesized by means of a reaction of imidoyl guanidine and a carboxylic acid chloride or an ester, as described in Journal of Synthetic Organic Chemistry, Japan, 1967, Vol. 25, No. 11, 1048 to 1051 can be adopted.

Specific examples of the compound represented by the formula (2) are shown below, but it should not be construed that the invention is limited to the following specific examples.

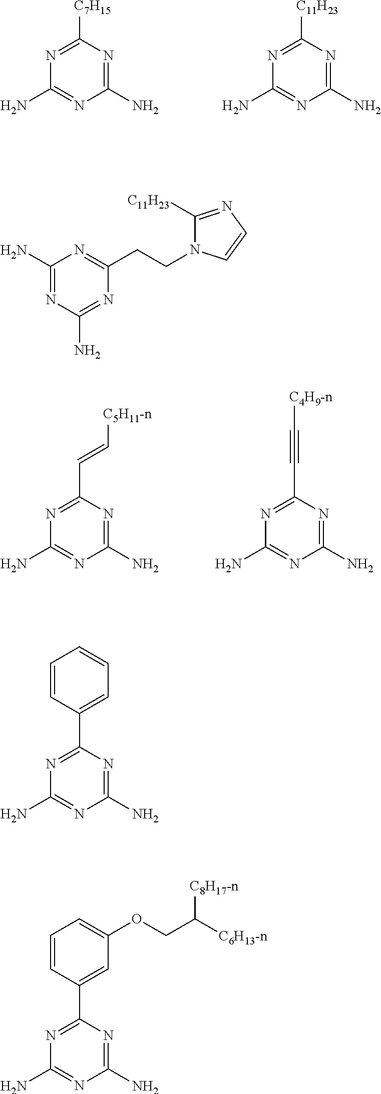

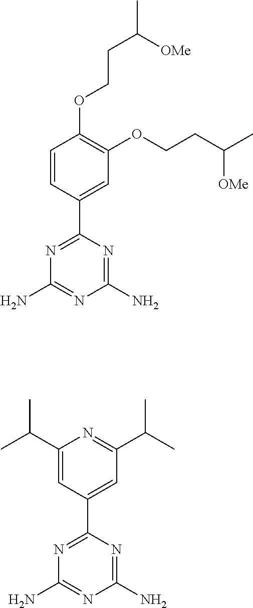

### (Compound Represented by the Formula (3))

Next, the compound represented by the formula (3) is described.

R¹²—CHO Formula (3)

In the formula (3), R¹² represents an alkyl group, an alkenyl group, an alkynyl group, an aryl group or a heterocyclic group.

R¹² in the formula (3) is synonymous with R² in the formula (1), and a preferred range thereof is also the same.

Specific examples of the compound represented by the formula (3) include acetaldehyde, butyl aldehyde and benzaldehyde. However, it should not be construed that the invention is limited to these specific examples.

An addition amount of the compound represented by the formula (3) is preferably from 2/1 to 20/1, more preferably from 4/1 to 15/1, and especially preferably from 5/1 to 10/1 from the viewpoint of a small environmental load in terms of a molar ratio relative to the compound represented by the formula (2).

### (Polycondensation Reaction)

In the manufacturing method of the invention, from the viewpoint of increasing the reactivity, it is preferable that the step of synthesizing a polymer is carried out in the presence of an acid material.

Examples of the acid material include known inorganic acids and known organic acids which are in general known as an acid catalyst. Examples of the acid catalyst include carboxylic acids such as acetic acid, lactic acid, succinic acid, oxalic acid, maleic acid, decanedicarboxylic acid and (meth)acrylic acid; sulfonic acids such as p-toluenesulfonic acid, dodecylbenzenesulfonic acid and dinonylnaphthalene (di)sulfonic acid; and organic alkyl phosphates such as dimethyl phosphate, dibutyl phosphate, dimethyl pyrophosphate and dibutyl pyrophosphate. Of these organic acids, from the standpoint of curing properties, sulfonic acids are preferable, and dodecylbenzenesulfonic acid, p-toluenesulfonic acid and dinonylnaphthalene (di)sulfonic acid are especially preferable. Meanwhile, though the inorganic acid is not particularly limited, above all, it is especially preferable to use p-toluenesulfonic acid.

The acid catalyst may be used upon being blocked with a blocking agent. The blocking agent is described in JP-A-2007-23157. Also, commercially available products of the acid catalyst are described in JP-A-2007-23157.

Though an addition amount of the acid catalyst cannot be unequivocally determined, it is suitable that the addition amount of the acid catalyst is from 0.1 to 10.0% by mass, preferably from 0.2 to 8.0% by mass, and more preferably from 0.3 to 5.0% by mass relative to the compound represented by the formula (2). When the addition amount of the acid catalyst is 0.1% by mass or more, curing sufficiently proceeds, whereas when it is not more than 10.0% by mass, problems such as a failure of liquid stability of the dope are not caused.

In the manufacturing method of the invention, it is preferable that the step of synthesizing a polymer is carried out in the absence of solvent. Though in conventional general amino resins, formaldehyde was used as the aldehyde source, the manufacturing method of the invention is characterized in that the aldehyde represented by the formula (3) is used for polycondensation of the amino resin without using formaldehyde. In such an aldehyde represented by the formula (3), a reaction rate of the polycondensation with the compound represented by the formula (2) is largely slow in the presence of a solvent as compared with that using formaldehyde, and therefore, it is preferable to allow the both compounds to react directly with each other in the absence of a solvent.

Specifically, it is preferable to carry out the polycondensation in an embodiment in which the acid catalyst is added in a mixture of the compound represented by the formula (2) and the compound represented by the formula (3) in the absence of a solvent, followed by refluxing under heating. From the viewpoint of enhancing the reaction rate, it is preferable to carry out refluxing under heating in this way.

In this connection, in the manufacturing method of the invention, as described later, though it is preferable to add the acid catalyst in the absence of a solvent, the acid catalyst may be a hydrate. For example, as a preferred example of the hydrate of the acid catalyst, a hydrate of a sulfonic acid can be exemplified, and p-toluenesulfonic acid monohydrate is more preferable. Also, even in the case where the acid catalyst that is a hydrate is added in the absence of a solvent, from the viewpoint of enhancing the reaction rate, it is preferable to carry out refluxing under heating.

Meanwhile, so far as the manufacturing cost is disregarded to some extent, it should not be construed that the manufacturing method of the invention is limited to the embodiment in which the step of synthesizing a polymer is carried out in the absence of a solvent.

Also, in the manufacturing method of the invention, it is preferable to synthesize the polymer while achieving control in such a manner that the polymer after completion of the step of synthesizing a polymer does not contain a functional group capable of causing a crosslinking reaction with hydroxyl groups of the cellulose acylate. Examples of the functional group capable of causing a crosslinking reaction with hydroxyl groups of the cellulose acylate include a functional group (for example, an aldehyde group, etc.) derived from a compound capable of causing a crosslinking reaction with an aldehyde (for example, formaldehyde or the unreacted compound represented by the formula (3)); a methylol group (—CH₂OH group) which the amino resin precursor has; a methylol group with an intermediate after the polycondensation reaction of the amino resin precursor has partially proceeded has; and a reactive group derived from the compound represented by the formula (3) in the case where progress of the polycondensation reaction between the compound represented by the formula (2) and the compound represented by the formula (3) is insufficient.

By synthesizing the polymer while controlling in this way, in the cellulose acylate film of the invention, it is possible to prevent the occurrence of crosslinking between the cellulose acylate and the amino resin with each other while making a reactive amino resin precursor absent in the cellulose acylate dope. As the method of achieving control in such a manner that the polymer does not contain a functional group capable of causing a crosslinking reaction with hydroxyl groups of the cellulose acylate, in addition to the foregoing refluxing under heating, there can be exemplified a known method for allowing the polycondensation to completely proceed, and the like.

Also, in the manufacturing method of the cellulose acylate film of the invention, from the viewpoint of removing a compound having a functional group capable of causing a crosslinking reaction with hydroxyl groups of the cellulose acylate prior to mixing with the cellulose acylate, it is preferable to include a step of preparing the cellulose acylate by acylating hydroxyl groups of the cellulose with an acylating agent, thereby obtaining the cellulose acylate film under a condition under which the hydroxyl groups of the cellulose do not react with other material than the acylating agent.

Specifically, in the step of synthesizing a polymer, it is preferable to include a step of aliquoting the polymer from a reaction mixture containing the polymer. A method of aliquoting the polymer from the resulting reaction mixture is not particularly limited, and known methods can be adopted. For example, filtration or washing can be exemplified.

Also, it is preferable that after collection by filtration and/or washing of the polymer, the resulting crude product of the polymer is dissolved in a solvent capable of dissolving the polymer therein and then reprecipitated. Though the solvent capable of dissolving the polymer therein is not particularly limited, examples thereof include ethyl acetate, tetrahydrofuran, methylene chloride and chloroform, with ethyl acetate being preferable. Though a solvent for reprecipitating the polymer is not particularly limited, examples thereof include hexane, toluene and xylene, with hexane being preferable.

Also, it is preferable to include a step of drying the polymer after being reprecipitated. From the viewpoint of removing a volatile aldehyde (for example, formaldehyde or the unreacted compound represented by the formula (3)), it is preferable that the dried polymer resulting from drying of the polymer after the reprecipitation in this way is mixed with the cellulose acylate.

Besides, a known concentration method for increasing a purity of the polymer represented by the formula (1), or a known method capable of removing the unreacted compound represented by the formula (2) or the unreacted compound represented by the formula (3) may be adopted. Also, in the case where the polycondensation reaction between the compound represented by the formula (2) and the compound represented by the formula (3) has not completely proceeded, a post-treatment for allowing the polycondensation reaction to further proceed, or a treatment for protecting a reactive functional group which an intermediate after the polycondensation reaction has partially proceeded has may be adopted.

### <Step of Preparing a Dope>

The cellulose acylate film of the invention is preferably a film having been subjected to film formation by means of solution film formation (solvent casting). In the solvent casting, a dope prepared by dissolving the polymer in an organic solvent is cast on the surface of a support made of a metal or the like and then dried to achieve film formation. Thereafter, the film is stripped off from the support surface and subjected to a stretching treatment, thereby manufacturing the cellulose acylate film of the invention.

### (Solvent)

The cellulose acylate film of the invention is favorable in redissolution properties in a solvent which is in general used for the solution film formation of a cellulose acylate film. Examples of the solvent which is in general used for the solution film formation of a cellulose acylate film include chlorine based solvents composed of a chlorine based organic solvent as a prime solvent; and non-chlorine based solvents which do not contain a chlorine based organic solvent.

At the preparation of a solution of the cellulose acylate which is used in the invention, a chlorine based organic solvent is preferably used as the prime solvent. In the invention, within the range where the cellulose acylate can be dissolved, cast and subjected to film formation, the kind of the chlorine based organic solvent is not particularly limited so far as its purpose can be achieved. Such a chlorine based organic solvent is preferably dichloromethane or chloroform, with dichloromethane being especially preferable. Also, it is not particularly problematic to mix an organic solvent other than the chlorine based organic solvent. In that case, it is necessary to use dichloromethane in an amount of at least 50% by mass in the whole amount of the organic solvents. Other organic solvent which is used in combination with the chlorine based organic solvent in the invention is hereunder described. That is, a solvent selected from esters, ketones, ethers, alcohols and hydrocarbons each having from 3 to 12 carbon atoms is preferable as other organic solvent. Each of the esters, ketones, ethers and alcohols may have a cyclic structure. A compound having any two or more functional groups of esters, ketones and ethers (namely, —O—, —CO— and —COO—) can also be used as the solvent, and such a compound may have other functional group, for example, an alcoholic hydroxyl group at the same time. In the case of a solvent having two or more kinds of functional groups, its carbon atom number may fall within the specified range of the compound having any one functional group. Examples of the ester having from 3 to 12 carbon atoms include ethyl formate, propyl formate, pentyl formate, methyl acetate, ethyl acetate and pentyl acetate. Examples of the ketone having from 3 to 12 carbon atoms include acetone, methyl ethyl ketone, diethyl ketone, diisobutyl ketone, cyclopentanone, cyclohexanone and methyl cyclohexanone. Examples of the ether having from 3 to 12 carbon atoms include diisopropyl ether, dimethoxymethane, dimethoxyethane, 1,4-dioxane, 1,3-dioxolane, tetrahydrofuran, anisole and phenetol. Examples of the organic solvent having two or more kinds of functional groups include 2-ethoxyethyl acetate, 2-methoxyethanol and 2-butoxyethanol.

Also, the alcohol which is used in combination with the chlorine based organic solvent may be preferably linear, branched or cyclic, and above all, a saturated aliphatic hydrocarbon is preferable. The hydroxyl group of the alcohol maybe primary, secondary or tertiary. Examples of the alcohol include methanol, ethanol, 1-propanol, 2-propanol, 1-butanol, 2-butanol, t-butanol, 1-pentanol, 2-methyl-2-butanol and cyclohexanol. In this connection, a fluorine based alcohol is also useful as the alcohol. Examples thereof include 2-fluoroethanol, 2,2,2-trifluoroethanol and 2,2,3,3-tetrafluoro-1-propanol. Furthermore, the hydrocarbon may be linear, branched or cyclic. Any of an aromatic hydrocarbon or an aliphatic hydrocarbon is useful. The aliphatic hydrocarbon may be saturated or unsaturated. Examples of the hydrocarbon include cyclohexane, hexane, benzene, toluene and xylene. As an example of the combination of the chlorine based organic solvent and other organic solvent, the following compositions can be exemplified, but it should not be construed that the invention is limited thereto.
Dichloromethane/methanol/ethanol/butanol (80/10/5/5 in terms of parts by mass)
Dichloromethane/acetone/methanol/propanol (80/10/5/5 in terms of parts by mass)
Dichloromethane/methanol/butanol/cyclohexane (80/10/5/5 in terms of parts by mass)
Dichloromethane/methyl ethyl ketone/methanol/butanol (80/10/5/5 in terms of parts by mass)
Dichloromethane/acetone/methyl ethyl ketone/ethanol/isopropanol (75/10/10/5/7 in terms of parts by mass)
Dichloromethane/cyclopentanone/methanol/isopropanol (80/10/5/8 in terms of parts by mass)
Dichloromethane/methyl acetate/butanol (80/10/10 in terms of parts by mass)
Dichloromethane/cyclohexanone/methanol/hexane (70/20/5/5 in terms of parts by mass)
Dichloromethane/methyl ethyl ketone/acetone/methanol/ethanol (50/20/20/5/5 in terms of parts by mass)
Dichloromethane/1,3-dioxolane/methanol/ethanol (70/20/5/5 in terms of parts by mass)
Dichloromethane/dioxane/acetone/methanol/ethanol (60/20/10/5/5 in terms of parts by mass)
Dichloromethane/acetone/cyclopentanone/ethanol/isobutanol/cyclohexane (65/10/10/5/5/5 in terms of parts by mass)
Dichloromethane/methyl ethyl ketone/acetone/methanol/ethanol (70/10/10/5/5 in terms of parts by mass)
Dichloromethane/acetone/ethyl acetate/ethanol/butanol/hexane (65/10/10/5/5/5 in terms of parts by mass)
Dichloromethane/methyl acetoacetate/methanol/ethanol (65/20/10/5 in terms of parts by mass)
Dichloromethane/cyclopentanone/ethanol/butanol (65/20/10/5 in terms of parts by mass)

Next, the non-chlorine based organic solvent which is preferably used at the preparation of a solution of the cellulose acylate is described. In the invention, within the range where the cellulose acylate can be dissolved, cast and subjected to film formation, the non-chlorine based organic solvent is not particularly limited so far as its purpose can be achieved. The non-chlorine based organic solvent which is used in the invention is preferably a solvent selected from esters, ketones and ethers each having from 3 to 12 carbon atoms. Each of the esters, ketones and ethers may have a cyclic structure. A compound having any two or more functional groups of esters, ketones and ethers (namely, —O—, —CO— and —COO—) can also be used as a prime solvent, and such a compound may have other functional group, for example, an alcoholic hydroxyl group. In the case of a prime solvent having two or more kinds of functional groups, its carbon atom number may fall within the specified range of the compound having any one functional group. Examples of the ester having from 3 to 12 carbon atoms include ethyl formate, propyl formate, pentyl formate, methyl acetate, ethyl acetate and pentyl acetate. Examples of the ketone having from 3 to 12 carbon atoms include acetone, methyl ethyl ketone, diethyl ketone, diisobutyl ketone, cyclopentanone, cyclohexanone and methyl cyclohexanone. Examples of the ether having from 3 to 12 carbon atoms include diisopropyl ether, dimethoxymethane, dimethoxyethane, 1,4-dioxane, 1,3-dioxolane, tetrahydrofuran, anisole and phenetol. Examples of the organic solvent having two or more kinds of functional groups include 2-ethoxyethyl acetate, 2-methoxyethanol and 2-butoxyethanol.

Though the foregoing non-chlorine based organic solvent which is used for the cellulose acylate is selected from the foregoing various viewpoints, it is preferably as follows. That is, the non-chlorine based solvent is preferably a mixed solvent composed of the foregoing non-chlorine based organic solvent as a prime solvent and is a mixed solvent of three or more kinds of solvents which are different from each other, in which a first solvent is at least one member selected from methyl acetate, ethyl acetate, methyl formate, ethyl formate, acetone, dioxolane and dioxane, or a mixed solvent thereof; a second solvent is selected from ketones or acetoacetic acid esters each having from 4 to 7 carbon atoms; and a third solvent is selected from alcohols or hydrocarbons each having from 1 to 10 carbon atoms, and more preferably alcohols having from 1 to 8 carbon atoms. In this connection, in the case where the first solvent is a mixed solution of two or more kinds of solvents, the second solvent may be omitted. The first solvent is more preferably methyl acetate, acetone, methyl formate, ethyl formate or a mixture thereof; and the second solvent is preferably methyl ethyl ketone, cyclopentanone, cyclohexanone or methyl acetylacetate, and it may be a mixed solvent thereof.

The alcohol that is the third solvent may be linear, branched or cyclic, and above all, a saturated aliphatic hydrocarbon is preferable. The hydroxyl group of the alcohol maybe primary, secondary or tertiary. Examples of the alcohol include methanol, ethanol, 1-propanol, 2-propanol, 1-butanol, 2-butanol, t-butanol, 1-pentanol, 2-methyl-2-butanol and cyclohexanol. In this connection, a fluorine based alcohol is also useful as the alcohol. Examples thereof include 2-fluoroethanol, 2,2,2-trifluoroethanol and 2,2,3,3-tetrafluoro-1-propanol. Furthermore, the hydrocarbon may be linear, branched or cyclic. Any of an aromatic hydrocarbon or an aliphatic hydrocarbon is useful. The aliphatic hydrocarbon may be saturated or unsaturated. Examples of the hydrocarbon include cyclohexane, hexane, benzene, toluene and xylene. Such an alcohol or hydrocarbon that is the third solvent may be used alone or in admixture of two or more kinds thereof and is not particularly limited. With respect to a specific compound which is preferable as the third solvent, examples of the alcohol include methanol, ethanol, 1-propanol, 2-propanol, 1-butanol, 2-butanol and cyclohexanol; and examples of the hydrocarbon include cyclohexane and hexane. Above all, methanol, ethanol, 1-propanol, 2-propanol and 1-butanol are especially preferable.

With respect to a mixing proportion of the mixed solvent of three kinds of solvents, it is preferable to contain from 20 to 95% by mass of the first solvent, from 2 to 60% by mass of the second solvent and from 2 to 30% by mass of the third solvent; it is more preferable to contain from 30 to 90% by mass of the first solvent, from 3 to 50% by mass of the second solvent and from 3 to 25% by mass of the third solvent; and it is especially preferable that from 30 to 90% by mass of the first solvent, from 3 to 30% by mass of the second solvent and from 3 to 15% by mass of the third solvent, in the whole amount of the mixed solvent. The non-chlorine based organic solvent which is used in the invention is described in more detail in Journal of Technical Disclosure, No. 2001-1745, pages 12 to 16 (issued on Mar. 15, 2001 by Japan Institute of Invention and Innovation).

As a preferred combination of the non-chlorine based solvents, the following can be exemplified, but it should not be construed that the invention is limited thereto.
Methyl acetate/acetone/methanol/ethanol/butanol (75/10/5/5/5 in terms of parts by mass)
Methyl acetate/acetone/methanol/ethanol/propanol (75/10/5/5/5 in terms of parts by mass)
Methyl acetate/acetone/methanol/butanol/cyclohexane (75/10/5/5/5 in terms of parts by mass)
Methyl acetate/acetone/ethanol/butanol (81/8/7/4 in terms of parts by mass)
Methyl acetate/acetone/ethanol/butanol (82/10/4/4 in terms of parts by mass)
Methyl acetate/acetone/ethanol/butanol (80/10/4/6 in terms of parts by mass)
Methyl acetate/methyl ethyl ketone/methanol/butanol (80/10/5/5 in terms of parts by mass)
Methyl acetate/acetone/methyl ethyl ketone/ethanol/isopropanol (75/10/10/5/7 in terms of parts by mass)
Methyl acetate/cyclopentanone/methanol/isopropanol (80/10/5/8 in terms of parts by mass)
Methyl acetate/acetone/butanol (85/5/5 in terms of parts by mass)
Methyl acetate/cyclopentanone/acetone/methanol/butanol (60/15/15/5/6 in terms of parts by mass)
Methyl acetate/cyclohexanone/methanol/hexane (70/20/5/5 in terms of parts by mass)
Methyl acetate/methyl ethyl ketone/acetone/methanol/ethanol (50/20/20/5/5 in terms of parts by mass)
Methyl acetate/1,3-dioxolane/methanol/ethanol (70/20/5/5 in parts by mass)
Methyl acetate/dioxane/acetone/methanol/ethanol (60/20/10/5/5 in terms of parts by mass)
Methyl acetate/acetone/cyclopentanone/ethanol/isobutanol/cyclohexane (65/10/10/5/5/5 in terms of parts by mass)
Methyl formate/methyl ethyl ketone/acetone/methanol/ethanol (50/20/20/5/5 in terms of parts by mass)
Methyl formate/acetone/ethyl acetate/ethanol/butanol/hexane (65/10/10/5/5/5 in terms of parts by mass)
Acetone/methyl acetoacetate/methanol/ethanol (65/20/10/5 in terms of parts by mass)
Acetone/cyclopentanone/ethanol/butanol (65/20/10/5 in terms of parts by mass)
Acetone/1,3-dioxolane/ethanol/butanol (65/20/10/5 in terms of parts by mass)
1,3-Dioxolane/cyclohexanone/methyl ethyl ketone/methanol/butanol (55/20/10/5/5/5 in terms of parts by mass)

Furthermore, cellulose acylate solutions prepared by the following methods can also be used.
Method in which a cellulose acylate solution is prepared using methyl acetate/acetone/ethanol/butanol (81/8/7/4 in terms of parts by mass), and after filtration and concentration, 2 parts by mass of butanol is additionally added.
Method in which a cellulose acylate solution is prepared using methyl acetate/acetone/ethanol/butanol (84/10/4/2 in terms of parts by mass), and after filtration and concentration, 4 parts by mass of butanol is additionally added.
Method in which a cellulose acylate solution is prepared using methyl acetate/acetone/ethanol (84/10/6 in terms of parts by mass), and after filtration and concentration, 5 parts by mass of butanol is additionally added.

The dope which is used in the invention may contain, in addition to the foregoing non-chlorine based organic solvent, dichloromethane in an amount of not more than 10% by mass of the whole amount of the organic solvents.

Among the foregoing solvents, in particular, a combination of a chlorine based organic solvent and an alcohol can be preferably used because when used as the solvent at the time of preparing a dope, the cellulose acylate film of the invention has favorable redissolution properties therein. Above all, it is preferable to use a solvent containing methylene chloride, and it is more preferable to use a solvent in which at least methylene chloride and methanol are used in combination.

### <Step of Subjecting the Dope to Solution Casting Film Formation>

With respect to the manufacturing method of the cellulose acylate film utilizing the solvent casting method, the descriptions of, for example, U.S. Pat. Nos. 2,336,310, 2,367,603, 2,492,078, 2,492,977, 2,492,978, 2,607,704, 2,739,069 and 2,739,070, U.K. Patents Nos. 640,731 and 736,892, JP-B-45-4554, JP-B-49-5614, JP-A-60-176834, JP-A-60-203430 and JP-A-62-115035 can be made herein by reference. Also, the cellulose acylate film may be subjected to a stretching treatment. With respect to the method and condition of the stretching treatment, examples described in, for example, JP-A-62-115035, JP-A-4-152125, JP-A-4-284211, JP-A-4-298310 and JP-A-11-48271 can be made herein by reference.

### [Polarizing Plate]

The cellulose acylate film of the invention can be used as a protective film of polarizing plate (the polarizing plate of the invention). An example of the polarizing plate of the invention is composed of a polarizing film and two polarizing plate protective films (transparent films), each of which protects each surface of the polarizing film, and includes the cellulose acylate film of the invention as at least one of the polarizing plate protective films. With respect to an embodiment in which the cellulose acylate film of the invention is utilized as a support, and an optically anisotropic layer composed of a liquid crystal composition is provided on the surface thereof, in the case of utilizing the cellulose acrylate film of the invention as the protective film of the polarizing plate, it is preferable that the back surface (the surface on the side on which the optically anisotropic layer is not formed) of the cellulose acylate film of the invention that is the support is stuck on the surface of the polarizing film.

In the case of using the cellulose acylate film of the invention as the protective film of the polarizing plate, it is preferable to previously hydrophilize the cellulose acylate film of the invention upon being subjected to the foregoing surface treatment (also described in JP-A-6-94915 and JP-A-6-118232). It is preferable to apply, for example, a glow discharge treatment, a corona discharge treatment or an alkali saponification treatment. In particular, when the cellulose acylate film of the invention is a cellulose acetate film, the alkali saponification treatment is most preferably adopted as the surface treatment.

Also, for example, a film obtained by dipping a polyvinyl alcohol film in an iodine solution and stretching it or the like can be used as the polarizing film. In the case of using the polarizing film obtained by dipping a polyvinyl alcohol film in an iodine solution and stretching it, the surface-treated surface of the cellulose acylate film of the invention can be stuck directly onto the both surfaces of the polarizing film using an adhesive. In the manufacturing method of the invention, it is preferable that the cellulose acylate film is stuck directly onto the polarizing film. An aqueous solution of polyvinyl alcohol or a polyvinyl acetal (for example, polyvinyl butyral) or a latex of a vinyl based polymer (for example, polybutyl acrylate) can be used as the adhesive. The adhesive is especially preferably an aqueous solution of fully saponified polyvinyl alcohol.

In general, a liquid crystal display device has four polarizing protective films because a liquid crystal cell is provided between two polarizing plates. Though the cellulose acylate film of the invention may be used for any of the four polarizing plate protective films, the cellulose acylate film of the invention is especially useful as a protective film which is disposed between a polarizing film and a liquid crystal layer (liquid crystal cell) in the liquid crystal display device. Also, the protective film to be disposed on the opposite side of the cellulose acylate film of the invention sandwiching the polarizing film can be provided with a transparent hard coat layer, an antiglare layer, an anti-reflection layer or the like, and in particular, it is preferably used as a protective film of polarizing plate on the outermost surface on the display side of the liquid crystal display device.

### [Liquid Crystal Display Device]

The cellulose acylate film of the invention and the optically compensatory film and the polarizing plate each utilizing the same can be used for liquid crystal display devices of various display modes. Each of liquid crystal modes in which such a film us used is hereunder described. Among those modes, the cellulose acylate film of the invention and the optically compensatory film and polarizing plate each utilizing the same are especially preferably used for liquid crystal display devices of a VA mode. Such a liquid crystal display device may be any of a transmission type, a reflection type or a semi-transmission type.

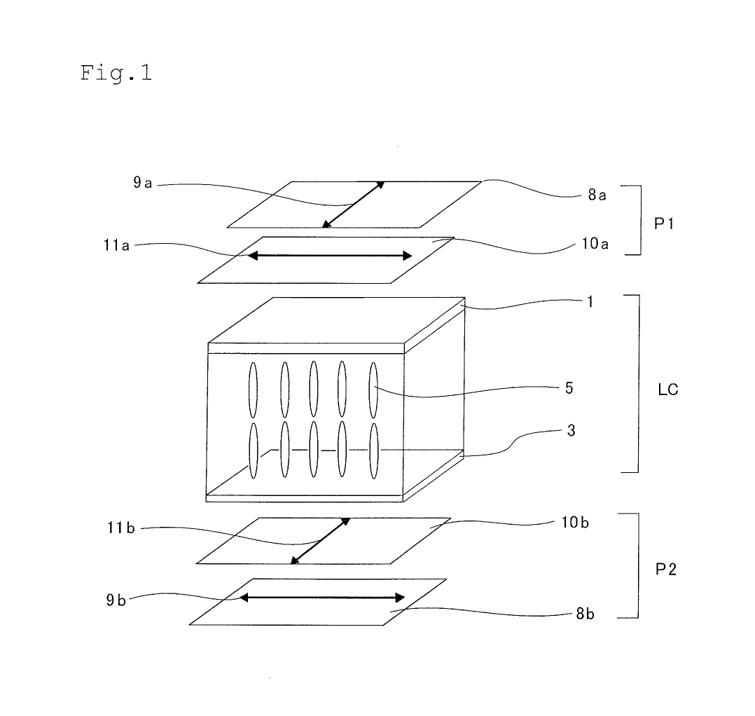

FIG. 1 shows a sectional schematic view of an example of the liquid crystal display device of the invention. In this connection, in FIG. 1, an upper part is defined as the observer's side (display surface), and a lower part is defined as the backlight side.

The liquid crystal display device of a VA mode of FIG. 1 includes a liquid crystal cell LC (composed of an upper substrate 1, a lower substrate 3 and a liquid crystal layer 5) and a pair of an upper polarizing plate P1 and a lower polarizing plate P2 disposed sandwiching the liquid crystal cell LC. In this connection, though it is general that a polarizing film is incorporated as a polarizing plate having a protective film on the both surfaces thereof into a liquid crystal display device, an outer protective film of the polarizing film is omitted in FIG. 1. The polarizing plates P1 and P2 have polarizing films 8a and 8b, respectively and are disposed in such a manner that their absorption axes 9a and 9b are orthogonal to each other. The liquid crystal cell LC is a liquid crystal cell of a VA mode, and at the time of black display, as shown in FIG. 1, the liquid crystal layer 5 is homeotropically aligned. Each of the upper substrate 1 and the lower substrate 3 has an alignment film (not illustrated) and an electrode layer (not illustrated) in an inner surface thereof, and a color filter layer (not illustrated) is provided on the inner surface of the substrate 1 on the observer's side.

Retardation films 10a and 10b are disposed between the upper substrate 1 and the upper polarizing film 8a and between the lower substrate 3 and the lower polarizing film 8b, respectively. Each of the retardation films 10a and 10b is the cellulose acylate film of the invention. The retardation films 10a and 10b are disposed in such a manner that their in-plane slow axes 11a and 11b are orthogonal to the absorption axes 9a and 9b of the upper polarizing film 8a and the lower polarizing film 8b, respectively. That is, the retardation films 10a and 10b are disposed in such a manner that the respective slow axes are orthogonal to each other. The retardation films 10a and 10b each of which is constituted of the cellulose acylate film of the invention contribute to reductions of light leakage and color shift generated in the oblique direction at the time of black display.

### EXAMPLES

The present invention will be further specifically explained with reference to the following examples of the present invention. The materials, amounts, ratios, types and procedures of treatments and so forth shown in the following examples can be suitably changed unless such changes depart from the gist of the present invention. Accordingly, the scope of the present invention should not be construed as limited to the following specific examples.

### Synthesis Example 1

### Synthesis of Compounds A to D

Compound A was synthesized using, as raw materials, 20 g of benzoguanamine and 73 g of benzaldehyde and the following solvent and catalyst under other manufacturing condition according to the following method.

p-Toluenesulfonic acid monohydrate (0.5 g, 2.6 mmoles) was added in a mixture of benzoguanamine (20 g, 107 mmoles) and benzaldehyde (73 g, 690 mmoles) with stirring, and the mixture was refluxed under heating for 3 hours. After cooling to room temperature, the reaction mixture was gradually added to hexane (300 mL), and a deposit was collected by means of filtration and then washed with hexane. A solution of the resulting crude product having been redissolved in ethyl acetate was added dropwise to hexane, thereby achieving reprecipitation. The product was collected by means of filtration and then dried.

As a result, there was obtained desired Compound A (yield: 25.1 g, percent yield: 85%). A weight average molecular weight of Compound A was 1,480.

A chemical structure thereof was confirmed by means of NMR spectrum, MS spectrum and elementary analysis.

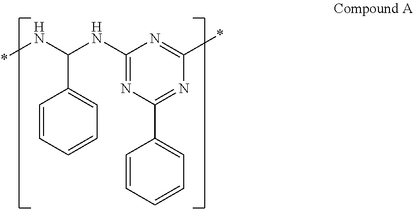

Also, Compounds B and C were synthesized in the same manner as in the synthesis of Compound A. Weight average molecular weights of Compounds B and C were 1,260 and 1,900, respectively.

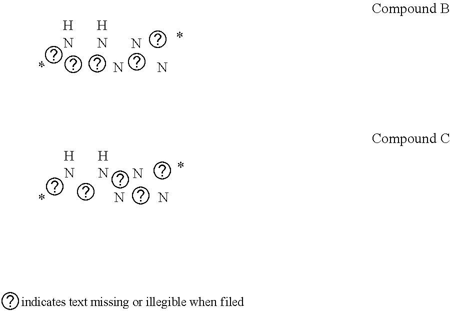

Also, Compound D was synthesized in the same manner as in the synthesis of Compound A, except for carrying out the copolymerization in the following manner.

p-Toluenesulfonic acid monohydrate (0.1 g, 0.53 mmoles) was added in a mixture of benzoguanamine (30 g, 160 mmoles), benzaldehyde (89.1 g, 840 mmoles) and butyl aldehyde (20.2 g, 280 mmoles) with stirring, and the mixture was refluxed under heating for 3 hours.

A weight average molecular weight of Compound D was 1,100. However, in Compound D, a numerical value at the lower right of each of the brackets expresses a copolymerization ratio (molar ratio).

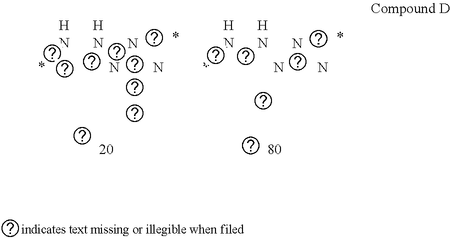

### Example 1

### (Fabrication of Cellulose Acylate Film)

To 100 parts by mass of a cellulose acylate described in the following Table 2, the foregoing Compound A was added in an addition amount (4% by mass) described in the following Table 2, and the mixture was further mixed with a solvent composed of 410 parts by mass of methylene chloride and 45 parts by mass of methanol, thereby preparing a cellulose acylate (specifically, cellulose acetate) solution. This solution was cast using a band casting machine, and the resulting web was stripped off from the band and then stretched in a ratio of 35% in the TD direction (film width direction) under a condition at 140° C., followed by drying to fabricate a cellulose acylate film (specifically, cellulose acetate) film having a film thickness of 50 μm. This was used as a film of Example 1.

### Examples 2 to 9 and Comparative Examples 1 to 3

Films of Examples 2 to 9 shown in the following Table 2 were fabricated in the same manner as in the fabrication of the film of Example 1, except for changing the kind and addition amount of the additive to be used as described in the following Table 2. Meanwhile, an additive-free film was manufactured as a film of Comparative Example 1. Also, a film of Comparative Example 2 was manufactured using, as the additive, a compound synthesized according to the method of Example 6 of JP-A-9-194555, which is a condensate (polymer) of benzoguanamine and formaldehyde. Moreover, a film of Comparative Example 3 was manufactured using, as the additive, Comparative Compound 1 having the following structure, which is a precursor for undergoing a crosslinking reaction with the cellulose acylate in the dope.

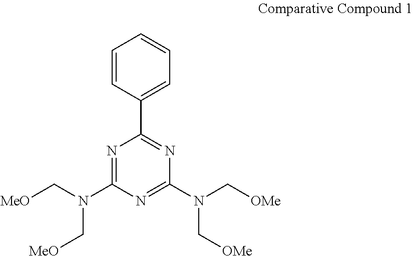

### (Humidity Dependency of Re and Rth)

Each of the resulting films of the respective Examples and Comparative Examples was subjected to sampling three times at three points in the width direction (center and ends (positions with 5% of the whole width of the both ends, respectively)) at an interval of 10 m in the longitudinal direction; nine samples having a size of 3 cm in square were taken out; and the humidity dependency of Re and Rth was determined from an average value at each point according to the following method.

After subjecting the sample film to humidity control at 25° C. and a relative humidity of 10% for 12 hours, retardations at a wavelength of 590 nm were measured from the vertical direction to the film surface and the directions inclined to −50° to +50° at an interval of 10° over the normal direction of the film surface with the slow axis as an inclined axis (a rotation axis) at 25° C. and a relative humidity of 60% using an automatic double refractometer (KOBRA 21ADH, manufactured by Oji Scientific Instruments), from which were then calculated an in-plane retardation value (Re) and a retardation value (Rth) in a film thickness direction. Also, Re and Rth were calculated by the measurement in the same method as described above, except for carrying out the humidity control at 25° C. and a relative humidity of 80% for 12 hours. The humidity dependency of Re (ΔRe (10%-80%)) and the humidity dependency of Rth (ΔRth (10%-80%) were calculated on the basis of these values.

### (Redissolution Properties)

In order to evaluate the redissolution properties, the solubility of each of the resulting cellulose acylate films in a methylene chloride/methanol mixed solvent was determined and evaluated according to the following method. The results are described in the following Table 2.

100 parts by mass of the cellulose acylate film was added to 492 parts by mass of methylene chloride and 54 parts by mass of methanol, and the mixture was swollen and then stirred at room temperature for 12 hours. The solubility was evaluated by means of visual inspection according to the following criteria.

A: Transparent

B: Slightly turbid

C: Cloudy

D: Insoluble matter observed

TABLE 2

| | Additive | | Cellulose acetate | | | |
|---|---|---|---|---|---|---|
| | | Addition amount | Degree of acetyl | ΔRe (10% - 80%) | ΔRth (10%-80%) | Redissolution |
| | Compound | (% by mass) | substitution | [nm] | [nm] | properties |
| Example 1 | A | 4 | 2.42 | 10.5 | 22.0 | A |
| Example 2 | A | 6 | 2.42 | 8.5 | 16.0 | A |
| Example 3 | B | 4 | 2.42 | 10.8 | 21.7 | A |
| Example 4 | B | 6 | 2.42 | 8.9 | 15.8 | B |
| Example 5 | C | 4 | 2.42 | 10.0 | 18.8 | A |
| Example 6 | C | 6 | 2.42 | 8.7 | 14.5 | A |
| Example 7 | D | 4 | 2.42 | 10.8 | 19.7 | A |
| Example 8 | D | 6 | 2.42 | 8.8 | 15.0 | A |
| Example 9 | A | 6 | 2.86 | 6.7 | 14.8 | A |
| Comparative | No | 0 | 2.42 | 15.1 | 33.4 | A |
| Example 1 | | | | | | |
| Comparative | Condensate of formaldehyde and | 6 | 2.42 | The evaluation was | The evaluation was | — |
| Example 2 | benzoguanamine | | | impossible because the | impossible because the | |
| | | | | additive is insoluble | additive is insoluble | |
| | | | | in the solvent. | in the solvent. | |
| Comparative | Comparative Compound 1 | 6 | 2.42 | 12.1 | 25.2 | D |
| Example 3 | (precursor for undergoing a | | | | | |
| | crosslinking reaction with the | | | | | |
| | cellulose acylate in the dope) | | | | | |

It was noted from the results shown in the foregoing Table 2 that all of the films of the invention are favorable in the redissolution properties and as compared with the films of the respective Comparative Examples, are favorable in the humidity of Re and Rth. Also, in Comparative Example 2 using a condensate (polymer) of formaldehyde and benzoguanamine, namely a condensate (polymer) in which R² in the formula (1) is a hydrogen atom, the subject condensate (polymer) was insoluble in the solvent, and only a cloudy film was obtained, so that the evaluation could not be made. In Comparative Example 3, the cellulose film was not redissolved in the solvent.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 2010-083039, filed on Mar. 31, 2010, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A cellulose acylate film comprising a polymer having a repeating unit represented by the following formula (1) and a cellulose acylate. 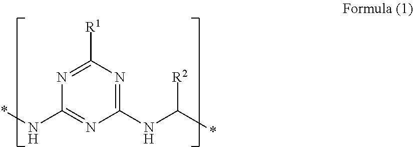
wherein R¹ represents an alkyl group having 2 or more carbon atoms, an alkenyl group, an alkynyl group, an aryl group or a heterocyclic group; and R² represents an alkyl group, an alkenyl group, an alkynyl group, an aryl group or a heterocyclic group.

2. The cellulose acylate film according to claim 1, wherein in the formula (1), R¹ is an alkyl group having 2 or more carbon atoms or an aryl group.

3. The cellulose acylate film according to claim 1, wherein in the formula (1), R¹ is a phenyl group.

4. The cellulose acylate film according to claim 1, wherein in the formula (1), R² is an alkyl group or an aryl group.

5. The cellulose acylate film according to claim 1, wherein the polymer having a repeating unit represented by the formula (1) has a weight average molecular weight of from 500 to 10,000.

6. The cellulose acylate film according to claim 1, wherein the cellulose acylate does not form a crosslinking structure with the polymer having a repeating unit represented by the formula (1).

7. The cellulose acylate film according to claim 1, wherein hydroxyl groups of the cellulose constituting the cellulose acylate are substituted with only an acyl group.

8. The cellulose acylate film according to claim 1, wherein the cellulose acylate has a total degree of acyl substitution of from 1.5 to 3.

9. A method for manufacturing a cellulose acylate film comprising:
polycondensing a compound represented by the following formula (2) and a compound represented by the following formula (3) to obtain a polymer,
mixing the polymer with a cellulose acylate to prepare a dope, and
subjecting the dope to solution casting film formation to obtain a cellulose acylate film. 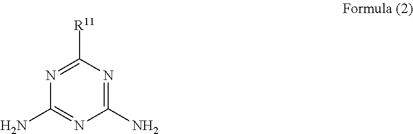
wherein R¹¹ represents an alkyl group having 2 or more carbon atoms, an alkenyl group, an alkynyl group, an aryl group or a heterocyclic group.
R¹²—CHO Formula (3)
wherein R¹² represents an alkyl group, an alkenyl group, an alkynyl group, an aryl group or a heterocyclic group.

10. The method for manufacturing a cellulose acylate film according to claim 9, wherein the polycondensation is carried out in the presence of an acid substance.

11. The method for manufacturing a cellulose acylate film according to claim 9 wherein the polycondensation is carried out in the absence of a solvent.

12. The method for manufacturing a cellulose acylate film according to claim 9 wherein the polymer is synthesized while controlling such that the polymer after completion of the polycondensation does not contain a functional group capable of undergoing a crosslinking reaction with hydroxyl groups of the cellulose acylate.

13. The method for manufacturing a cellulose acylate film according to claim 9, which further comprises:
preparing the cellulose acylate by acylating hydroxyl groups of the cellulose with an acylating agent, thereby obtaining the cellulose acylate film under a condition under which the hydroxyl groups of the cellulose do not react with other material than the acylating agent.

14. A cellulose acylate film manufactured by the method for manufacturing a cellulose acylate film of claim 9.

15. A retardation film comprising the cellulose acylate film of claim 1.

16. A polarizing plate comprising a polarizer and the retardation film of claim 15.

17. A liquid crystal display device comprising the polarizing plate of claim 16.
